(19) United States
(12) Patent Application Publication
(10) Pub. No.: US 2026/0319789 A1
(43) Pub. Date: Oct. 15, 2026

(54) GENERATING OF SEQUENCE DIAGRAMS FOR VISUALIZING BEHAVIOR-DRIVEN DEVELOPMENT TEST SCRIPTS

(71) Applicant: Capital One Financial Corporation, McLean, VA (US)

(72) Inventor: Evgenii Klepilin, Denton, TX (US)

(21) Appl. No.: 19/284,503

(22) Filed: Jul. 29, 2025

Related U.S. Application Data
(60) Provisional application No. 63/787,163, filed on Apr. 11, 2025.

(51) Int. Cl. G06F 8/73

(52) U.S. Cl. CPC G06F 8/73

(57) ABSTRACT

Techniques for visualizing a behavior-driven development (BDD) test script in a graphical form involve (i) obtaining a given BDD test script that defines at least one behavioral scenario for a software application, (ii) transforming the BDD test script into corresponding diagram source code for use in generating a sequence diagram that represents the given BDD test script, the corresponding diagram source code representing interactions between entities involved in the at least one behavioral scenario, and (iii) causing the sequence diagram to be generated and displayed to a user. Transforming the given BDD test script involves parsing each given line of the given BDD test script, evaluating whether the given line satisfies any transformation rules, and if the given line satisfies a transformation rule, carrying out a transformation action to transform the given line into a corresponding line that is represented according to a syntax of the diagram source code.

### CROSS-REFERENCE TO RELATED APPLICATIONS

This application claims priority to U.S. Provisional Application No. 63/787,163, filed Apr. 11, 2025, and entitled “Generating Of Sequence Diagrams For Visualizing Behavior-Driven Development Test Scripts,” the contents of which are incorporated by reference herein in their entirety.

### BACKGROUND

Developing software is a complex undertaking that often requires collaboration between multiple different individuals across multiple different phases, examples of which may include planning, requirement definition, design, coding, testing, deployment, and maintenance, among other possible phases. However, the individuals that are involved in these different phases of the software development lifecycle typically have varying levels of technical expertise. For instance, teams of individuals involved in the software development lifecycle may include both technical members (e.g., software developers) and non-technical members (e.g., software testers, business personnel, etc.), which may give rise to several problems. For example, there may be situations where certain aspects of defining the functional requirements, design plans, and/or test plans for the software being developed end up being too technical for non-technical team members or too high level and abstract for technical team members, which can then introduce errors, delays, and/or other inefficiencies into the software development process.

To address these problems with the software development process, a software development framework referred to as behavior-driven development (“BDD”) has been created. BDD focuses the process of developing software on the intended behavior of the software being implemented. Further, BDD enables streamlined collaboration between technical and non-technical individuals (collectively referred to herein as “stakeholders”) that are involved in the software development process by using human-friendly syntax (e.g., natural language) that is easily understood regardless of technical expertise to communicate regarding the software's intended behavior and desired user experience.

The BDD framework typically involves (i) a discovery phase, where the software's functional requirements are defined by the stakeholders, (ii) a formulation phase, where scripts for BDD tests defining different behavioral scenarios are created, each behavioral scenario designed to test a particular aspect of the software's functionality based on the occurrence of certain one or more actions, and (iii) a testing phase that involves running the BDD tests to evaluate how the software behaves in the different behavioral scenarios.

Based on running the BDD tests, software code defining the software's functionality can be adjusted until the software behaves as intended.

### BRIEF DESCRIPTION OF THE DRAWINGS

FIG. 1 depicts a portion of an example BDD test script based on which a sequence diagram may be generated in accordance with aspects of the disclosed software technology.

FIG. 2 depicts an example computing environment in which aspects of the disclosed software technology may be implemented.

FIG. 3 depicts example software components that may carry out functionality in accordance with aspects of the disclosed software technology.

FIG. 4 depicts a portion of example diagram source code that may be generated based on the BDD test script of FIG. 1, in accordance with aspects of the disclosed software technology.

FIGS. 5A-5J collectively depict an example sequence diagram that may be generated based on the diagram source code of FIG. 4, in accordance with aspects of the disclosed software technology.

FIG. 6A, FIG. 6B, FIG. 6C, and FIG. 6D depict example GUI views that may be displayed to a user for facilitating conversion of a BDD test script into diagram source code and generation of a sequence diagram based on the diagram source code, in accordance with aspects of the disclosed software technology.

FIG. 7 depicts an example flow chart of functionality that may be carried out for converting a BDD test script into diagram source code and generating a sequence diagram based on the converted diagram source code, in accordance with aspects of the disclosed software technology.

FIG. 8 depicts a structural diagram of an example back-end computing platform that may be configured to carry out one or more functions in accordance with aspects of the disclosed software technology.

FIG. 9 depicts a structural diagram of an example client device that may be configured to communicate with the example computing platform of FIG. 7 and also carry out one or more functions in accordance with aspects of the disclosed software technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As described above, a BDD framework enables stakeholders with varying levels of technical expertise to collaborate on different aspects of the software development process, including defining functional requirements of the software, creating and implementing BDD tests for evaluating the software's behavior and corresponding end-user experience in different behavioral scenarios. As BDD has gained popularity, various software tools for creating and automating BDD tests have been developed.

A BDD test script generally takes the form of a sequence of lines that includes syntax for testing software behavior during a given behavioral scenario. The syntax of a BDD test script may be defined by any one of various different formatting languages that are compatible with a BDD test automation software tool that can be used to automatedly run the BDD test. For instance, as one possibility, a BDD test script may be created using Gherkin, which is a plain-text, human-readable format that describes, from a user-perspective, actions and expected outcomes corresponding to a behavioral scenario. A script that is created using Gherkin is typically stored within a file that uses a “feature” extension and is thus commonly referred to as a “feature file.” Gherkin utilizes certain keywords that each indicate a respective aspect of the behavioral scenario. These keywords include, for example, a “Scenario” keyword which denotes text that provides a title and/or description of a behavioral scenario, a “Given” keyword which denotes text that establishes one or more pre-conditions (e.g., a known state or context) for the behavioral scenario, a “When” keyword which denotes text that describes an action, and a “Then” keyword which denotes text that describes an expected outcome of an action. Further, keywords such as “And” and “But” can be used in conjunction with the “Given,” “When,” and “Then” keywords to describe additional pre-conditions, actions, or exceptions.

A BDD test script may take other forms as well.

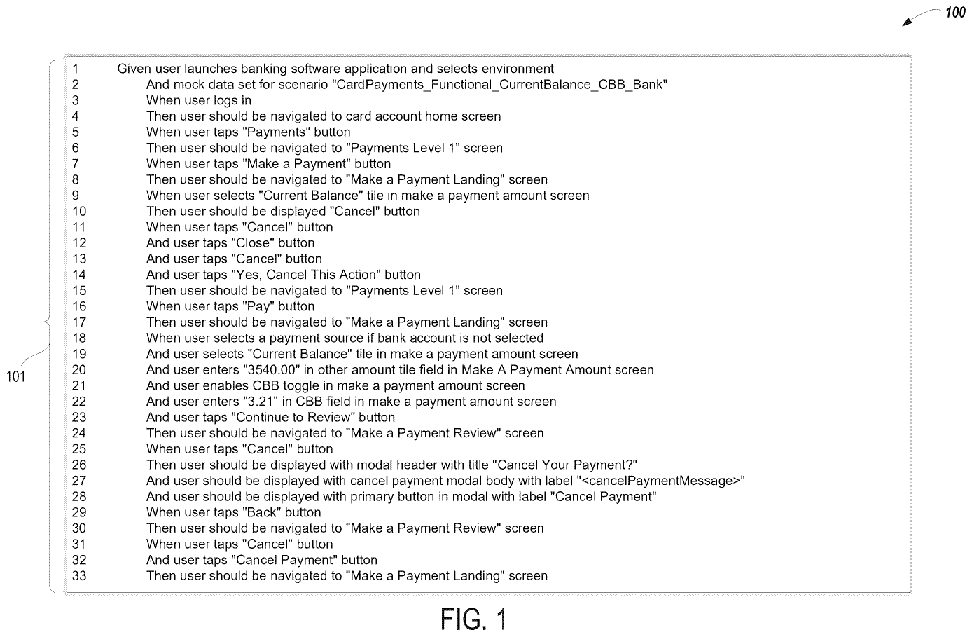

FIG. 1 provides one illustrative example of a portion of an example BDD test script 100 that is created using a Gherkin format. As shown in FIG. 1, the example BDD test script 100 comprises a series of lines 101 describing a behavioral scenario for a banking software application. For instance, line 1 beginning with the keyword “Given” and line 2 beginning with the keyword “And” collectively indicate pre-conditions for the behavioral scenario (i.e., a user launches the banking software application and navigates to a particular environment). Further, the example BDD test script 100 sets forth a sequence of action-outcome relationships for testing the banking software application's functionality related to making card payments, where each action-outcome relationship represents one or more actions to be performed by an actor (which in this example is a user of the software application) and one or more corresponding outcomes that should occur as a result of the one or more actions. For example, lines 3 and 4 of the example BDD test script 100 set forth a first action-outcome relationship, wherein line 3 describes a first action denoted by the keyword “When” (i.e., the user logs in) and line 4 describes a corresponding first outcome denoted by the keyword “Then” (i.e., the user should be navigated to an account home screen). As another example, lines 5 and 6 of the example BDD test script 100 set forth a second action-outcome relationship, wherein line 5 describes a second action denoted by the keyword “When” (i.e., the user taps a “Payments” button) and line 6 describes a corresponding second outcome denoted by the keyword “Then” (i.e., the user should be navigated to a “Payments Level 1” screen). Lines 7-32 of the BDD test script 100 represent additional action-outcome relationships for the behavioral scenario to be tested, including certain action-outcome relationships that include multiple actions to be performed in order to trigger an expected outcome (e.g., lines 11-14 representing a four-action trigger for the expected outcome represented by line 15).

After a BDD test script such as the example shown in FIG. 1 is created (e.g., in a text editor, an IDE, or the like), that BDD test script may be loaded into a software application that is configured to run BDD test scripts, which is sometimes referred to as a “BDD platform,” and that BDD platform may then function to execute the BDD test script-which thereby causes the BDD platform to automatically carry out the at least one behavioral scenario defined by the BDD test script as a means of automatically testing the functionality of the software application.

As shown in FIG. 1, the example BDD test script 100 comprises many lines that represent many different action-outcome relationships for testing the banking software application's functionality. In practice, a BDD test script may comprise tens or hundreds of lines. Therefore, it can be challenging to review a test script for completeness and accuracy, and errors in the test script can be difficult to find or inadvertently overlooked, which in turn can interfere with testing by causing the software to behave in an unintended manner due to errors in the test script, rather than errors in the software code. For instance, a clerical or typographical error in test script syntax may cause software to behave differently than expected, but identifying such an error may prove to be very difficult. Firstly, unintended behavior in the software functionality typically points to errors in the program code for the software itself, and thus software testers are likely to begin with trying to identify errors in the software program code in an attempt to fix the unintended behavior, and it may take a long amount of time to realize that the unintended behavior is actually due to an error in the test script. Secondly, reviewing the test script is also challenging for the reasons described above. Further, in practice, a software application may have hundreds or even thousands of corresponding BDD test scripts that serve to test various functional aspects of a software application's functionality, and reviewing each BDD test script on a line-by-line basis to ensure that the BDD test script fully and accurately captures the behavioral scenarios to be tested can be cumbersome, tedious, and prone to human-error.

For these and other reasons, there is a need for software technology that is capable of transforming BDD test scripts into another form that allows such BDD test scripts to be reviewed in a more effective way. However, existing software applications for creating, running, or otherwise interacting with BDD test scripts generally fail to include technology for transforming BDD test scripts into another form that allows such BDD test scripts to be reviewed in a more effective way. Instead, the existing software applications for creating, running, or otherwise interacting with BDD test scripts typically only allow for the presentation of the BDD test script in its native form, which as noted above can be difficult to review for completeness and accuracy.

To address these and other problems, disclosed herein is new software technology for visualizing a BDD test script in the form of a diagram that represents the BDD test script in a graphical manner, such as a sequence diagram, a flow chart, or the like. At a high level, the disclosed software technology may involve (i) obtaining a BDD test script that defines at least one behavioral scenario for a software application (e.g., a BDD test script created using a Gherkin syntax), (ii) transforming the BDD test script into a set of source code for use in rendering a sequence diagram that represents the BDD test script (e.g., a set of Mermaid code), which may be referred to herein as “diagram source code”, (iii) utilizing the diagram source code to generate the sequence diagram that represents the BDD test script (e.g., a Mermaid diagram), and (iv) causing the sequence diagram to be presented to a user.

The disclosed software technology may provide various advantages over existing software applications for creating, running, and/or otherwise interacting with BDD test scripts. For instance, by providing a representation of a diagram that represents a BDD test script in both text-based form (e.g., source code for rendering a sequence diagram representing the BDD test script) and graphical form (e.g., the sequence diagram representing the BDD test script), the disclosed software technology, the disclosed software technology advantageously allows a user to leverage the benefits of both the text-based and graphical representations as needed. For example, the text-based representation (e.g., diagram source code) that is generated by the disclosed software technology is particularly useful in certain instances, such as for evaluating or updating the source code based on specific language included in the source code syntax, for integrating with third party platforms (e.g. GitHub, etc.), or for conserving resources during storing, presenting, and/or transferring a representation of the BDD test script (that might otherwise be expended using a graphical representation), among other possibilities. Further, by transforming a BDD test script into the form of a diagram that represents the BDD test script, the disclosed software technology advantageously allows a user to visually review and evaluate the BDD test script in a more convenient and accessible manner than parsing the text of the BDD test script, which in turn provides for more convenient and efficient review and revision of the BDD test script. Further yet, the disclosed software technology enables a diagram representing a BDD test script to be accessed concurrently via different forms. For instance, a user can utilize both a text-based representation (e.g., diagram source code) and a graphical representation (e.g., diagram) of the BDD test script (e.g., by viewing each representation side-by-side, etc.) at the same time, which may be useful in certain instances, such as for updating the diagram source code and concurrently viewing updates reflected in the diagram as a result of the updated diagram source code. The disclosed software technology provides other advantages as well.

The disclosed software technology may be incorporated into one or more software applications that may take any of various forms. As one possible implementation, the disclosed software technology may be incorporated into a client-server application (e.g., a web application such as a software as a service (“SaaS”) application) that includes both front-end software running on one or more client devices and back-end software running on a back-end computing platform (sometimes referred to as a “cloud” platform) that interacts with and/or drives the front-end software, where the front-end and back-end software work together to collectively carry out the functionality of the client-server application. As another possible implementation, the disclosed software technology may be incorporated into a software application that takes the form of front-end client software running on one or more client stations without interaction with a back-end computing platform, which is sometimes referred as a “native” application (e.g., a desktop or mobile application). Further, in practice, the software application that incorporates the disclosed technology could either be a dedicated application for generating visualizations of BDD test scripts or could be a software application that includes additional functionality for creating, running, and/or otherwise interacting with BDD test scripts (e.g., a BDD platform). The software technology disclosed herein may be incorporated into software applications that take other forms as well.

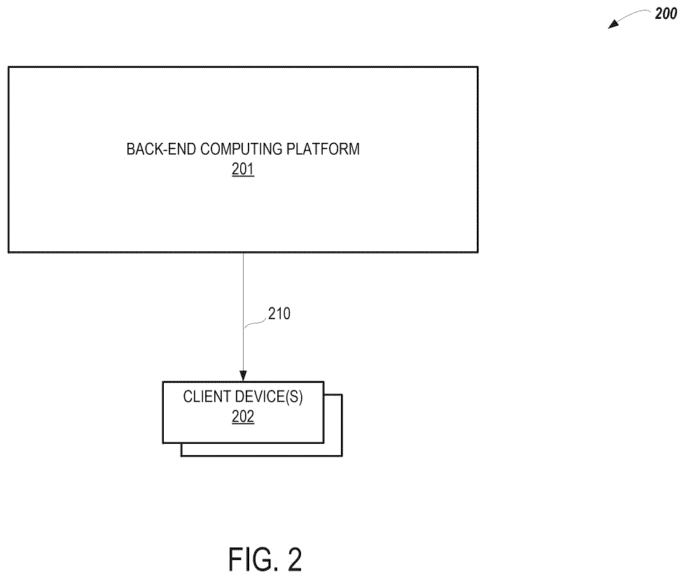

Further, disclosed software technology may be implemented in any of various different computing environments, which may depend on the type of software application that incorporates the disclosed software technology. One example of a computing environment in which the disclosed software technology may be implemented is shown in FIG. 2. As shown in FIG. 2, an example computing environment 200 may include a back-end computing platform 201 and one or more client devices 202, among other possibilities.

Broadly speaking, the back-end computing platform 201 may comprise any one or more computing units (e.g., one or more servers) that have been installed with software for carrying out back-end functionality for a client-server software application that incorporates the disclosed software technology. In practice, the one or more computing units of the back-end computing platform 201 may collectively comprise some set of physical computing resources (e.g., one or more processors, data storage system, communication interfaces, etc.), which may take any of various forms. As one possibility, the back-end computing platform 201 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 201 may comprise “on-premises” computing resources of the given provider (e.g., servers owned by the given provider). As yet another possibility, the back-end computing platform 201 may comprise a combination of cloud computing resources and on-premises computing resources. Other implementations of the back-end computing platform 201 are possible as well.

Further, in practice, the software for carrying out the back-end functionality disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

As shown, the back-end computing platform 102 may be communicatively coupled to each of the one or more client devices 202 via a respective communication path 210. In general, the one or more client devices 202 may each be any computing device that is capable of running front-end software that incorporates the disclosed software technology. In this respect, each client device 202 may include one or more hardware components, such as one or more processors, data storage, one or more communication interfaces, and one or more input/output (I/O) components (or interfaces for connecting thereto), among other possible hardware components, as well as software that enables the client device 202 to perform the front-end functionality of the client-server application that incorporates the disclosed software application (e.g., operating system software, web browser software, one or more native applications, etc.). As representative examples, each client device 202 may take the form of a desktop computer, a laptop, a netbook, a tablet, a smartphone, and/or a personal digital assistant (PDA), among other possibilities.

Further, in practice, the respective communication path 210 between the back-end computing platform 201 and each client device 202 may generally comprise one or more communication networks and/or communications links, which may take any of various forms. For instance, each respective communication path 210 may include any one or more of a Personal Area Network (PAN), a Local-Area Networks (LAN), a Wide-rea Networks (WAN) such as the Internet or a cellular network, a cloud network, and/or a point-to-point link, among other possibilities. Further, the communication networks and/or links that make up each respective communication path 210 may be wireless, wired, or some combination thereof, and may carry data according to any of various different communication protocols. Additionally, the communication between the back-end computing platform 201 and each client device 202 could be carried out via an Application Programming Interface (API), among other possibilities. Additionally yet, although not shown, the respective communication path 210 between the back-end computing platform 201 and each client device 202 may also include one or more intermediate systems, examples of which may include a data aggregation system or a host server, among other possibilities. Many other configurations are also possible.

It should be understood that the computing environment 200 is one example of a computing environment in which the disclosed software technology may be implemented, and that other examples of computing environments in which the disclosed software technology may be implemented are possible as well. For instance, in line with the discussion above, the disclosed software technology could be incorporated into a native software application that is designed to be installed and run on client devices without being driven by a back-end computing platform, in which case the computing environment may not necessarily include a back-end computing platform (although it is possible that the client devices installed with such a native application could still interact with a remote computing platform to facilitate certain functionality carried out while running the native application).

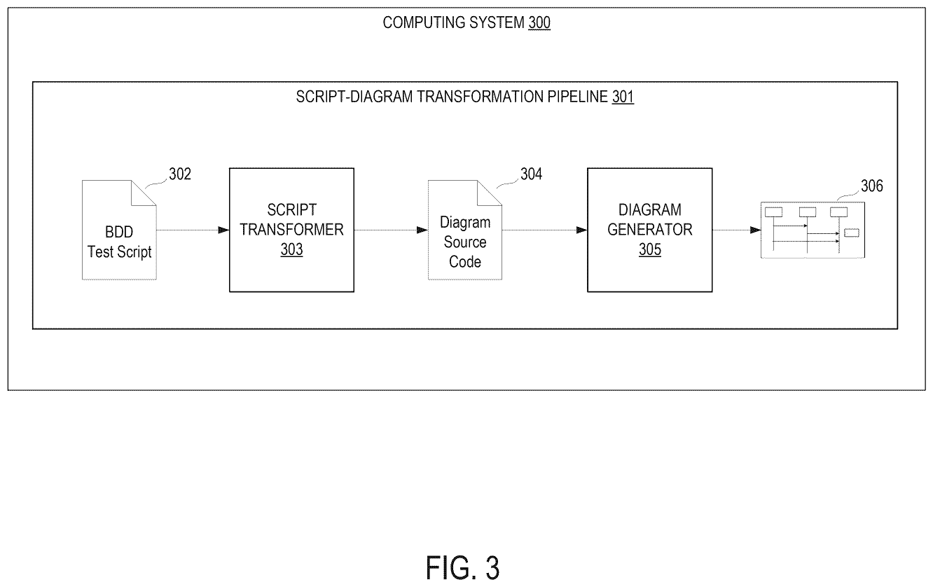

Turning next to FIG. 3, an example software-based pipeline 301 for transforming a BDD test script into a diagram that can be presented to a user is shown. In practice, the example software-based pipeline 301 may comprise a set of functional components, each of which may be encoded in the form of program instructions that are executable by one or more processors of one or more computing systems. For purposes of illustration, the example software-based pipeline 301 is described as being installed on and executed by a computing system 300, which could take the form of a back-end computing platform (e.g., the back-end computing platform 201 of FIG. 2, a client device (e.g., a client device 202), or a combination thereof (i.e., the functionality of the software-based pipeline 301 could be distributed between a back-end computing platform and a client device), among other possible implementations of the computing system 300. Further, it should be understood that the example software-based pipeline 301 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular

As shown in FIG. 3, the functional components of the example software-based pipeline 301 may include at least (i) a script transformer 303 that is configured to receive a BDD test script 302 as input and then transform the BDD test script 302 into a set of diagram source code 304 and (ii) a diagram generator 305 that is configured to receive the set of diagram source code 304 from the script transformer 303 and then generate a diagram 306 representing the BDD test script 302 based on the set of diagram source code 304. However, the functional components of the example software-based pipeline 301 could take various other forms as well.

The BDD test script 302 that is provided as input to the script transformer 303 may generally comprise any BDD test script for performing an automated test of a software application, which may take any of various forms. As one possibility, the BDD test script 302 may comprise a BDD test script that was created using Gherkin syntax and sets forth a sequence of action-outcome relationships that each comprises one or more actions and one or more corresponding expected outcomes for at least one behavioral scenario that is to be tested for the software application. The example BDD test script 100 that is shown and discussed above with reference to FIG. 1 provides one illustrative example of such a BDD test script that was created using Gherkin syntax. In line with the discussion above, the example BDD test script 100 shown in FIG. 1 sets forth a pre-condition and a sequence of action-outcome relationships for at least one behavioral scenario to be tested for a banking software application using keywords including “Given,” “When,” and “Then,” as described above.

The BDD test script 302 could also take other forms as well, examples of which may include a BDD test script created using RSpec (Ruby), SpecFlow (C#/.NET), JBehave (Java), Cucumber-JVM (Java, Kotlin, etc.), Behat (PHP), Lettuce (Python), Puppeteer (JavaScript/Node.js), or SharpSpec (C#), among other possible types of tools and syntax that can be used to create BDD scripts. Further, in practice, the BDD test script 302 could be provided as input to the software-based pipeline 301 by either inputting the BDD test script 302 into a client-side interface associated with the software-based pipeline 301 or loading a file that contains the BDD test script 302 (e.g., a feature file), among other possibilities.

As shown in FIG. 3, the script transformer 303 may transform the BDD test script 302 into the set of diagram source code 304 (e.g., by transforming the syntax of the BDD test script 302 into syntax for the set of diagram source code 304), which is then to be provided as input to the diagram generator 305.

The set of diagram source code 304 that is generated and output by the script transformer 303 may generally comprise source code having any type of syntax that can be used by the diagram generator 305 to generate the diagram 306 that represents the BDD test script 302, which may also be referred to herein as “diagram syntax.” For instance, as one possibility, the set of diagram source code 304 may take the form of a set of Mermaid source code for use in generating a sequence diagram, which is code having a text-based, markdown-like syntax that can be input into a Mermaid-based diagram generator 305.

At a high level, such a set of Mermaid source code comprises a series of lines that represent interactions between different entities over time, where each respective line in the set of Mermaid source code may take the form of (i) a line that represents a respective interaction between two entities (which may be referred to herein as an “interaction line”) or (ii) a line that represents a note comprising additional information regarding a particular entity or interaction (which may be referred to herein as an “note line”), among other possibilities. In this respect, each interaction line may include an identification of an initiating entity for the interaction, a target entity for the interaction, and a subject of the interaction. For instance, an interaction line within a set of Mermaid source code may have the following example form:
{INITIATING ENTITY}->> {TARGET ENTITY}: {SUBJECT},
   where “{INITIATING ENTITY}” represents an identification of the initiating entity of the interaction, “{TARGET ENTITY}” represents an identification of the target entity of the interaction, the “->>” symbol indicates that a directionality of the interaction between the identified entities (i.e., the entity on the left of the “->>” symbol is the initiator of the interaction and the entity on the right of the “->>” symbol is the target of the interaction), and “{SUBJECT}” represents an identification of the subject of the interaction. An interaction line within a set of Mermaid source code may have other forms as well, including but not limited to the possibility that the “->>” symbol could be replaced by some other type of symbol that provides further context regarding the interaction being represented.

In turn, each note line may include an identification of the location of the note within the sequence diagram (e.g., by referencing a location relative to an entity involved in an interaction represented by a preceding interaction line) and the subject of the note. For instance, a note line within a set of Mermaid source code may have the following example form:
{LOCATION}: {SUBJECT},
   where “{LOCATION}” represents an identification of the location of the note within the sequence diagram (e.g., “note right of {ENTITY}”) and “{SUBJECT}” represents an identification of the subject of the note.

A set of Mermaid source code could include other types of lines as well, examples of which may include (i) line that specifically identifies a particular entity as an actor that is to be represented by an actor icon within the sequence diagram, (ii) a line that identifies an alias for a particular entity, (iii) a line that creates, destroys, activates, or deactivates a particular entity, and/or (iv) a line that represents a loop within the sequence diagram, among other possible types of lines that could be included in a set of Mermaid source code.

Further, within a set of Mermaid source code a line representing the subject of an interaction, the subject of a note, an entity's name, or any other textual content could also include a <br/> symbol to represent that, when displayed within the sequence diagram, the textual content should be broken across two lines.

A set of Mermaid source code could take various other forms as well.

The examples described herein are largely described in the context of Mermaid source code for illustrative purposes. However, it should be understood that the set of diagram source code 304 that is generated and output by the script transformer 303 may take other forms as well. For instance, as some other non-limiting examples, the set of diagram source code 304 could take the form of PlantUML source code for use in rendering a UML sequence diagram or a Declarative Diagramming (D2) source code for use in rendering a D2 sequence diagram. Other examples are also possible.

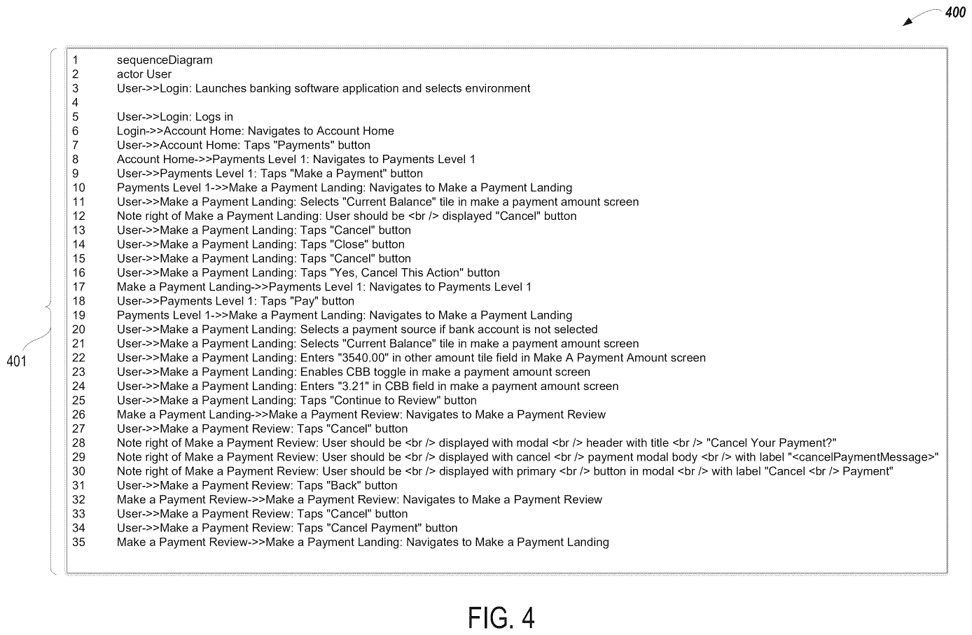

FIG. 4 provides one illustrative example of a set of Mermaid source code 400 that may be generated and output by the script transformer 303 for the example BDD test script 100 that is shown in FIG. 1. As shown in FIG. 4, the example set of Mermaid source code 400 comprises a series of lines 401 that generally serve to represent the behavioral scenario defined by the example BDD test script 100 in terms of interactions between entities involved in the behavioral scenario and perhaps also notes that provide additional information regarding particular interactions and/or entities—where each interaction between entities that is extracted from the example BDD test script 100 could take the form of (i) an interaction between an end-user of the banking software application and a software component of the software application or (ii) an interaction between two software components of the banking software application, among other possible examples of interactions between entities that could be extracted from the example BDD test script 100 and represented within the example set of Mermaid source code 400. In this respect, in line with the discussion above, each interaction between entities that is exacted from the example BDD test script 100 may be represented as an interaction line within the example set of Mermaid source code 400, and each note that is extracted from the example BDD test script 100 may be represented as a note line within the example set of Mermaid source code 400.

More particularly, as shown in FIG. 4, each of lines 3, 5-11 and 13-17 represents a respective interaction between an initiating entity (which may be either the user or a software component of the banking software application) and a target entity (which may be a software component of the banking software application) that is extracted from the example BDD test script 100.

To illustrate with a first example, line 3 of the example set of Mermaid source code 400 comprises an interaction line of the form:
User->>Login: Launches banking software application and selects environment,
   which represents a first interaction between a user of the banking software application (as the initiating entity) and a “Login” component of the banking software application (as the target entity) that involves the user interacting with the “Login” component in order to launch the banking software application and select an environment within the banking software application. This first interaction corresponds to line 1 of the example BDD test script 100, which represents an initial pre-condition of “user launches banking software application and selects environment.”

To illustrate with a second example, line 5 of the example set of Mermaid source code 400 comprises an interaction line of the form:
User->>Login: Logs in,
   which represents a second interaction between the user of the banking software application (as the initiating entity) and the “Login” component of the banking software application (as the target entity) that involves the user interacting with the “Login” component in order to log into the banking software application. This second interaction corresponds to line 3 of the example BDD test script 100, which represents an action in the form of “When user logs in.”

To illustrate with a third example, line 6 of the example set of Mermaid source code 400 comprises an interaction line of the form:
Login->>Account Home: Navigates to Account Home,
   which represents a third interaction between the “Login” component of the banking software application (as the initiating entity) and the “Account Home” component of the banking software application (as the target entity) that involves the “Login” component interacting with the “Account Home” component in order to cause the banking software application to navigate the user to a card account home screen. This third interaction corresponds to line 4 of the example BDD test script 100, which represents an expected outcome of “user should be navigated to card account home screen.”

The other interaction lines of the example set of Mermaid source code 400 have a similar form.

Moreover, each of lines 12 and 28-30 represent a respective note that provides additional information regarding a particular interaction and/or entity (which as noted above may be either the user or a software component of the banking software application).

To illustrate with a first example, line 12 of the example set of Mermaid source code 400 comprises a note line of the form:
Note right of Make a Payment Landing: User should be <br/> displayed “Cancel” button,
   which represents a first note associated with the interaction between the user and the “Make a Payment Landing” component of the banking software application represented by line 11 that is to be located to the right of the “Make a Payment Landing” component's lifeline and is to contain the text “User should be <br/> displayed ‘Cancel’ button” (where <br/> indicates a line break). This first note corresponds to line 10 of the example BDD test script 100, which represents an expected outcome of “user should be displayed a ‘Cancel’ button.”

To illustrate with a second example, line 28 of the example set of Mermaid source code 400 comprises a note line of the form:
Note right of Make a Payment Review: User should be <br/> displayed with modal <br/> header with title <br/> “Cancel Your Payment?”,
   which represents a second note associated with the interaction between the user and the “Make a Payment Review” component of the banking software application represented by line 27 that is to be located to the right of the “Make a Payment Review” component's lifeline and is to contain the text “User should be <br/> displayed with modal <br/> header with title <br/> ‘Cancel Your Payment?” (where <br/> indicates a line break). This second note corresponds to line 26 of the example BDD test script 100, which represents an expected outcome of “user should be displayed with modal header with title ‘Cancel Your Payment?’”.

The other note lines of the example set of Mermaid source code 400 have a similar form.

As further shown in FIG. 4, line 1 of the example set of Mermaid source code 400 may comprise an initialization statement for the sequence diagram, and line 2 of the example set of Mermaid source code 400 may comprise a line that specifically identifies the user as an “actor” type of entity.

Returning to FIG. 3, the diagram source code 304 may take other forms as well, examples of which may include PlantUML source code, yUML source code, or WebSequenceDiagrams (WSD) source code, among other possible types of source code that can be used as a basis for generating the diagram 306.

The functionality that is carried out by the script transformer 303 in order to transform the BDD test script 302 into the set of diagram source code 304 may take any of various forms. In at least some implementations, this functionality may involve a parsing process during which the script transformer 303 parses each respective line of the BDD test script 302 (or at least each of a subset of lines of the BDD test script 302) in order to (i) determine whether the respective line satisfies a transformation rule and (ii) if so, transform the respective line of the BDD test script 302 into a corresponding line that is to be added to the set of diagram source code 304. This parsing process may take any of various forms.

For instance, for each respective line of the BDD test script 302, the script transformer 303 may begin by evaluating whether the respective line satisfies any one of a set of transformation rules, each of which may comprise (i) a condition that must be met by the respective line in order for the transformation rule to be satisfied, which may take the form of a predefined pattern that must be matched in order for the transformation rule to be satisfied (e.g., regex-based or string-based pattern), and (ii) a transformation action that is to be performed if the condition is met, which may take the form of one or more operations for transforming the respective line (which is represented according to the syntax of the BDD test script 302) into a corresponding line that is represented according to the syntax of the diagram source code 304.

If the script transformer 303 determines based on the foregoing evaluation that the respective line does not satisfy any of the transformation rules (e.g., due to the script transformer 303 either cycling through the entire set of transformation rules without identifying a match or determining that the respective line satisfies a precursor condition for skipping over a line without checking the set of transformation rules), then the script transformer 303 may forgo transformation of the respective line and proceed to the next line in the BDD test script 302. On the other hand, if the script transformer 303 determines based on the foregoing evaluation that the respective line satisfies a given transformation rule of the set of transformation rules, the script transformer 303 may then (i) carry out the transformation action defined by the given transformation rule in order to transform the respective line in the BDD test script 302 into a corresponding line (or perhaps multiple corresponding lines) represented according to the syntax of the diagram source code 304 and (ii) add the corresponding line to the set of diagram source code 304.

In this respect, the corresponding line represented according to the syntax of the diagram source code 304 may be constructed from any one or more of (i) content from the respective line of the BDD test script 302 being parsed, (ii) content that is predefined (e.g., hard-coded) as part of the matched transformation rule, and/or (iii) other content that is extracted or inferred (either from contents of the BDD test script 302 or other content), such as an inference of which one or more software components of the software application are involved in activity represented by the respective line (to the extent that such one or more software components are not identified within the respective line), among other possible types of content.

In such scenarios where a particular line in the BDD test script does not indicate a specific target entity (e.g., software component with which the user interacts) and instead describes one or more actions performed by the user, the disclosed software technology (e.g., the script transformer 303) may determine the specific target entity in various ways. For example, as one possibility, the disclosed software technology may infer the target entity based on analyzing the contents of the BDD test script (e.g., other lines of the BDD test script). As another possibility, the disclosed software technology may determine the specific target entity based on information other than the contents of the BDD test script. For example, such information may include domain information (e.g., whether the disclosed software technology is launched via a mobile application, a web application, an application on an IoT device (e.g., a smart watch), among other possibilities). As another example, such information may include other information that is provided as input to the script transformer 303 (e.g., information identifying a “default” target entity that is to be used in a specific instance, such as when initiating the functionality for transforming a BDD test script 302, or when a particular type of domain is being utilized, among many other possibilities.). The target entity may be identified in other ways as well.

Further, in order to facilitate the script transformer's ability to extract or infer content that is applicable to the transformation of the respective line of the BDD test script 302 (e.g., which one or more software components are involved in activity represented by the respective line), the script transformer 303 may maintain and update certain state variables for the software application during the parsing process, examples of which may include (i) a “currentScreen” variable that indicates which screen component of the software application will currently be active at the point when the respective line of the BDD test script 302 being parsed will be executed by a BDD platform and/or (ii) a “previousScreen” variable that indicates which screen component of the software application was active immediately prior to switching to the currently-active screen component, among other possible types of state variables that may be maintained and updated by the script transformer 303 during the parsing process.

The script transformer 303 may carry out the foregoing functionality on a line-by-line basis during the course of the parsing process for the BDD test script 302, which may result in the script transformer 303 producing the corresponding diagram source code 304 on a line-by-line basis (although as noted above there may not be a one-to-one correspondence between the lines of the BDD test script 302 and the lines of the diagram source code 304 due to certain of the lines of the BDD test script 302 being skipped and/or certain of the lines of the BDD test script 302 being transformed into multiple corresponding lines). And once the parsing process for the BDD test script 302 is completed, the script transformer 303 may then output the diagram source code 304 to the diagram generator 305.

Depending on the implementation, the transformation rules that are evaluated by the script transformer 303 could take any of various forms. For instance, in an implementation where the syntax of the diagram source code 304 defines multiple different types of lines, then the set of transformation rules to be evaluated by the script transformer 303 may include different subsets of transformation rules for the different types of lines. To illustrate with a particular implementation in which the set of diagram source code 304 utilizes a Mermaid syntax discussed above, the set of transformation rules to be evaluated by the script transformer 303 could include (i) a first subset of transformation rules for interaction lines, each of which comprise a condition (e.g., a pattern) for identifying a BDD test script line that is to be transformed into an interaction line and a transformation action for constructing an interaction line that corresponds to the identified BDD test script line, and (ii) a second subset of transformation rules for note lines, which each of which comprise a condition (e.g., a pattern) for identifying a BDD test script line that is to be transformed into a note line and a transformation action for constructing a note line that corresponds to the identified BDD test script line. The particular transformation rules included in these interaction-specific and note-specific subsets of transformation rules could take any of various forms.

Beginning with the interaction-specific subset of transformation rules, one possible category of transformation rules within the interaction-specific subset may include (i) a condition in the form of a regex-based pattern comprising a phrase that indicates an action that may be performed by a user, such as a phrase that begins with the word “user” and is followed by a verb (e.g., “agrees,” “adds,” “changes,” “clicks,” “logs in,” “searches,” “taps,” or the like, among many other possibilities), which is indicative of a BDD test script line that can be represented as an interaction line in which the user is the initiating entity and the currently-active software component of the software application is the target entity, and (ii) a transformation action for constructing an interaction line corresponding to such a BDD test script line, which may involve (a) defining the initiating entity of the interaction line to have a hard-coded value of “User,” (b) defining the target entity of the interaction line to have a value that represents the currently-active software component of the software application at the point when the BDD test script line would be executed (e.g., by reading the value of a “currentScreen” state variable being maintained by the script transformer or otherwise inferring which software component of the software application would be currently active at the point when the matching BDD test script line would be executed), and (c) defining the subject of the interaction line to be the portion of the matching BDD test script line that starts with the verb included in the regex-based pattern (which may be capitalized (e.g., “(T|t) aps?”, etc.) and/or may account for varying instances of the verb (e.g., “verif (ylies”, etc.) and proceeds to the end of the matching BDD test script line.

To illustrate with an example, a BDD test script line comprising the statement “When user taps ‘Payments’ button” could match a transformation rule from this category having a regex-based pattern of “user taps” and could be transformed into a diagram source code line comprising “User->>Account Home: Taps ‘Payments’ button,” where the initiating entity of “User” is hard-coded into the transformation rule, the target entity of “Account Home” is read from the “currentScreen” state variable or otherwise inferred from the BDD test script 302, and the subject of “Taps ‘Payments’ button” comprises the portion of the BDD test script line that begins with the word “taps” (which has been capitalized in the subject of the diagram source code line). Many other examples are possible as well.

Another possible category of transformation rules within the interaction-specific subset may include (i) a condition in the form of a regex-based pattern comprising a phrase that indicates an action that may be performed by a software component to provide an outcome to a user, such as a phrase that begins with “user and is followed by a verb phrase (e.g., “should be navigated to,” “should be presented,” “should be able to,” “should see,” “should not be,” or the like, among many other possibilities), which is indicative of a BDD test script line that can be represented as an interaction line in which the initiating entity is the currently-active software component of the software application (e.g., the screen component that would currently be active at the point when the matching BDD test script line would be being executed) and the target entity is the software component of the software application to which the user will be navigated next (e.g., the next screen component), and (ii) a transformation action for constructing an interaction line corresponding to such a BDD test script line, which may involve (a) defining the initiating entity of the interaction line to have a value that represents the currently-active software component of the software application at the point when the BDD test script line would be executed (e.g., by reading the value of a “currentScreen” state variable being maintained by the script transformer or otherwise inferring which software component of the software application would be currently active at the point when the matching BDD test script line would be executed), (b) defining the target entity of the interaction line to have a value that represents the software component referenced in the BDD test script line after the verb phrase (e.g., “user should be navigated to,” etc.) and (c) defining the subject of the interaction line to have a value of “{verb} to {nextScreen}” where {nextScreen} is populated with the same value that represents the software component referenced in the BDD test script line after the verb phrase (e.g., “Navigates to {nextScreen}.”

To illustrate with an example, a BDD test script line comprising the statement “Then user should be navigated to ‘Payments Level 1’ screen” could match a transformation rule from this category having a regex-based pattern of “user should be navigated to” and could be transformed into a diagram source code line comprising “Account Home->>Payments Level 1: Navigates to Payments Level 1,” where the initiating entity of “Account Home” is read from a “currentScreen” state variable or otherwise inferred from the BDD test script 302, the target entity of “Payments Level 1” comprises the identifier of the next software component that is extracted from the BDD test line, and the subject of “Navigates to Payments Level 1” comprises the hard-coded phrase “Navigates to” followed by the same identifier of the next software component that is extracted from the BDD test line. Many other examples are possible as well.

Yet another possible category of transformation rules within the interaction-specific subset may include (i) a condition in the form of a regex-based pattern for identifying BDD test script lines having a more specific form (e.g., a pattern comprising a full statement that is expected to appear after a particular keyword, such as a WHEN or THEN keyword), and (ii) a transformation action for constructing an interaction line corresponding to such a BDD test script line, which may vary depending on specific form of the BDD test script line. In this respect, the transformation rules in this category (if any) may enable the script transformer 303 to apply more customized transformations to certain BDD test script lines that match such transformation rules. For example, if a BDD test script line matches one of the transformation rules in this category but would also match one of the other transformation rules that is designed to identify and transform a broader range of BDD test script line, the script transformer 303 may give preference to the matched transformation rule in this category (e.g., by evaluating this category's transformation rules first and then stopping the evaluation once a match is identified), which may result in the BDD test script line being transformed in a more customized way than it would have otherwise been transformed. Additionally, or alternatively, the transformation rules in this category (if any) may also enable the script transformer 303 to transform certain BDD test lines that would not match any of the other available transformation rules for interaction lines (e.g., BDD test script lines with unique forms and/or other corner cases).

Turning next to the note-specific subset, one possible category of transformation rules within the note-specific subset may include (i) a condition in the form of a regex-based pattern comprising a phrase that is indicative of an expected behavior the currently-active software component of the software application that does not involve interaction with or transition to a different software component of the software application, such as a phrase that begins with “user should be” followed by verb other than “navigated” or the like (e.g., “displayed,” “be shown,” “be presented,” “remain,” etc.), and (ii) a transformation action for constructing a note line corresponding to such a BDD test script line, which may involve (a) defining the location of the note to be a hard-coded location relative to the lifeline of the currently-active software component of the software application at the point when the matching BDD test script line would be executed, such as “Note right of {currentScreen}” (where {currentScreen} is determined by reading the value of a “currentScreen” state variable being maintained by the script transformer or otherwise inferring which software component of the software application would be currently active at the point when the matching BDD test script line would be executed), and (b) defining the subject of the note to be the portion of the matching BDD test script line that describes the expected behavior of the currently-active software component of the software application (e.g., the portion that starts with the word “user” and proceeds to the end of the BDD test script line).

To illustrate with an example, a BDD test script line comprising the statement “Then user should be displayed ‘Cancel’ button” could match a transformation rule from this category having a regex-based pattern of “user should be displayed” and could be transformed into a diagram source code line comprising “Note right of Make a Payment Landing: User should be <br/> displayed ‘Cancel” button,’ where the “Note right of” phrase is hard-coded into the transformation rule, the currently-active software component of “Make a Payment Landing” is read from the “currentScreen” state variable or otherwise inferred from the BDD test script 302, and the subject of “User should be <br/> displayed ‘Cancel” button” comprises the portion of the BDD test script line that begins with the word “user” (where “user” has been capitalized and a line break has been inserted). Many other examples are possible as well.

In other implementations, it is also possible that BDD test script lines representing an expected behavior the currently-active software component of the software application that does not involve interaction with or transition to a different software component of the software application could alternatively be transformed into interaction lines where the initiating entity and target entity are both the currently-active software component.

Another possible category of transformation rules within the note-specific subset may include (i) a condition in the form of a regex-based pattern comprising a phrase that is indicative of a precondition of the currently-active software component of the software application (e.g., “Given a,” “Given an account,” “Given user is,” “Given user with,” etc.), and (ii) a transformation action for constructing a note line corresponding to such a BDD test script line, which may involve (a) defining the location of the note to be a hard-coded location relative to the lifeline of the currently-active software component of the software application at the point when the matching BDD test script line would be executed, such as “Note left of {currentScreen}” (where {currentScreen} is determined by reading the value of a “currentScreen” state variable being maintained by the script transformer or otherwise inferring which software component of the software application would be currently active at the point when the matching BDD test script line would be executed), and (b) defining the subject of the note to be the portion of the matching BDD test script line that follows the “Given” keyword.

The set of transformation rules that are be evaluated by the script transformer 303 may take any of various other forms as well, and may ultimately depend on factors such as the format of the BDD test scripts, the types of software applications and behavioral scenarios that are to be using BDD test scripts, and/or any applicable guidelines for creating BDD test scripts that have been implemented by the organization using the disclosed software technology, among other possibilities. In this respect, in at least some implementations, it is possible that the disclosed software technology could allow users to customize the set of transformation rules that are to be evaluated by the script transformer 303. For example, it is possible that the script transformer 303 could be pre-configured to evaluate an initial set of transformation rules that are hard-coded into the script transformer 303, but that the initial set of transformation rules can be modified by a user of the disclosed software technology (e.g., by adding, removing, or changing transformation rules). As another example, the script transformer 303 could be configured to map variations of a particular term or phrase to a given instance of the term or phrase in order to increase consistency and uniformity in the diagram source code that is generated by the script transformer 303. Further, the parsing process that is carried out by the script transformer 303 in order to transform the BDD test script 302 into the set of diagram source code 304 may take other forms as well.

An illustrative example of how the parsing process of the script transformer 303 may work in practice will now be described with reference to the example BDD test script 100 of FIG. 1 and the example set of diagram source code 400 of FIG. 1.

In this illustrative example, the script transformer 303 may begin by initializing a “currentScreen” state variable to have a value of “Login,” which indicates that first software component of the banking software application to be active when the BDD test begins is expected to be the “Login” screen component.

After initializing the “currentScreen” state variable, the script transformer 303 may parse line 1 of example BDD test script 100, which comprises a statement of “Given user launches banking software application and selects environment.” This parsing function for test script line 1 may involve (i) determining that test script line 1 matches a transformation rule for an interaction line comprising a regex-pattern of “user launches,” and (ii) responsively constructing line 3 of the example diagram source code 400, which comprises a statement of “User->>Login: Launches banking software application and selects environment,” by (a) defining the initiating entity of diagram code line 3 to be “User” based on that value being hard-coded into the transformation rule, (b) defining the target entity of diagram code line 3 to be “Login” by reading that value from the “currentScreen” state variable (which as noted above may be initialized to have a value of “Login”), and (c) defining the subject of diagram code line 3 to be “Launches banking software application and selects environment” by extracting the portion of test script line 1 that begins with the word “launches” and capitalizing the word “launches.” Additionally, the script transformer 303 may keep the “currentScreen” state variable set to a value of “Login” because test script line 1 does not involve a change to the currently-active software component of the software application.

Next, the script transformer 303 may parse line 2 of example BDD test script 100, which comprises a statement of “And mock data set for scenario ‘CardPayments_Functional_CurrentBalance_CBB_Bank.’” This parsing function for test script line 2 may involve (i) determining that test script line 2 does not match any available transformation rule, and (ii) responsively skipping over test script line 2.

Next, the script transformer 303 may parse line 3 of example BDD test script 100, which comprises a statement of “When user logs in.” This parsing function for test script line 3 may involve (i) determining that test script line 3 matches a transformation rule for an interaction line comprising a regex-pattern of “user logs in,” and (ii) responsively constructing line 5 of the example diagram source code 400, which comprises a statement of “User->>Login: Logs in,” by (a) defining the initiating entity of diagram code line 5 to be “User” based on that value being hard-coded into the transformation rule, (b) defining the target entity of diagram code line 5 to be “Login” by reading that value from the “currentScreen” state variable, and (c) defining the subject of diagram code line 5 to be “Logs in” by extracting the portion of test script line 3 that begins with the word “logs” and capitalizing the word “logs.” Additionally, the script transformer 303 may keep the “currentScreen” state variable set to a value of “Login” because test script line 3 does not involve a change to the currently-active software component of the software application.

Next, the script transformer 303 may parse line 4 of example BDD test script 100, which comprises a statement of “Then user should be navigated to card account home screen.” This parsing function for test script line 4 may involve (i) determining that test script line 4 matches a transformation rule for an interaction line comprising a regex-pattern of “user should be navigated,” and (ii) responsively constructing line 6 of the example diagram source code 400, which comprises a statement of “Login->>Account Home: Navigates to Account Home,” by (a) defining the initiating entity of diagram code line 6 to be “Login” by reading that value from the “currentScreen” state variable, (b) defining the target entity of diagram code line 6 to be “Account Home” by extracting the phrase “card account home screen” from test script line 4 and then transforming it into an identifier of “Account Home,” and (c) defining the subject of diagram code line 6 to be “Navigates to Account Home” by using hard-coded phrase “Navigates to” followed by the “Account Home” identifier. Additionally, the script transformer 303 may update the “currentScreen” state variable to a value of “Account Home” because test script line 4 involves a change to the currently-active software component of the software application.

Next, the script transformer 303 may parse line 5 of example BDD test script 100, which comprises a statement of “When user taps ‘Payments’ button.” This parsing function for test script line 5 may involve (i) determining that test script line 5 matches a transformation rule for an interaction line comprising a regex-pattern of “user taps,” and (ii) responsively constructing line 7 of the example diagram source code 400, which comprises a statement of “User->>Account Home: Taps ‘Payments’ button,” by (a) defining the initiating entity of diagram code line 7 to be “User” based on that value being hard-coded into the transformation rule, (b) defining the target entity of diagram code line 7 to be “Account Home” by reading that value from the “currentScreen” state variable, and (c) defining the subject of diagram code line 7 to be “Taps ‘Payments’ button” by extracting the portion of test script line 5 that begins with the word “taps” and capitalizing the word “taps.” Additionally, the script transformer 303 may keep the “currentScreen” state variable set to a value of “Account Home” because test script line 5 does not involve a change to the currently-active software component of the software application.

Next, the script transformer 303 may parse line 6 of example BDD test script 100, which comprises a statement of “Then user should be navigated to “Payments Level 1” screen.” This parsing function for test script line 6 may involve (i) determining that test script line 6 matches a transformation rule for an interaction line comprising a regex-pattern of “user should be navigated,” and (ii) responsively constructing line 8 of the example diagram source code 400, which comprises a statement of “Account Home->>Payments Level 1: Navigates to Payments Level 1,” by (a) defining the initiating entity of diagram code line 8 to be “Account Home” by reading that value from the “currentScreen” state variable, (b) defining the target entity of diagram code line 8 to be “Payments Level 1” by extracting the phrase “Payments Level 1” from test script line 6, and (c) defining the subject of diagram code line 8 to be “Navigates to Payments Level 1” by using the hard-coded phrase “Navigates to” followed by the extracted “Payments Level 1” phrase. Additionally, the script transformer 303 may update the “currentScreen” state variable to a value of “Payments Level 1” because test script line 6 does involve a change to the currently-active software component of the software application.

The script transformer 303 may carry out similar parsing functionality for lines 7-8 of the example BDD test script 100, which may involve the script transformer 303 updating the “currentScreen” state variable to a value of “Make a Payment Landing.”

Next, the script transformer 303 may parse line 9 of example BDD test script 100, which comprises a statement of “When user selects ‘Current Balance’ tile in make a payment amount screen.” This parsing function for test script line 9 may involve (i) determining that test script line 9 matches a transformation rule for an interaction line comprising a regex-pattern of “user selects,” and (ii) responsively constructing line 11 of the example diagram source code 400, which comprises a statement of “User->>Make a Payment Landing: Selects ‘Current Balance’ tile in make a payment amount screen,” by (a) defining the initiating entity of diagram code line 11 to be “User” based on that value being hard-coded into the transformation rule, (b) defining the target entity of diagram code line 11 to be “Make a Payment Landing” by reading that value from the “currentScreen” state variable, and (c) defining the subject of diagram code line 11 to be “Selects ‘Current Balance’ tile in make a payment amount screen” by extracting the portion of test script line 9 that begins with the word “selects” and capitalizing the word “selects.” Additionally, the script transformer 303 may keep the “currentScreen” state variable set to a value of “Make a Payment Landing” because test script line 9 does not involve a change to the currently-active software component of the software application.

Next, the script transformer 303 may parse line 10 of example BDD test script 100, which comprises a statement of “Then user should be displayed ‘Cancel’ button.” This parsing function for test script line 10 may involve (i) determining that test script line 10 matches a transformation rule for a note line comprising a regex-pattern of “user should be displayed,” and (ii) responsively constructing line 12 of the example diagram source code 400, which comprises a statement of “Note right of Make a Payment Landing: User should be <br/> displayed ‘Cancel’ button,” by (a) defining the location of the diagram code line 12 to be “Note right of Make a Payment Landing” by using the hard-coded phrase “Navigates to” in combination with the value of the “currentScreen” state variable and (b) defining the subject of diagram code line 12 to be “User should be <br/> displayed ‘Cancel’ button” by extracting the portion of test script line 10 that follows the “Then” keyword and capitalizing the word “user.” Additionally, the script transformer 303 may again keep the “currentScreen” state variable set to a value of “Make a Payment Landing” because test script line 10 does not involve a change to the currently-active software component of the software application.

The script transformer 303 may then continue to parse the rest of the lines in the example BDD test script 100 in a similar manner.

The functionality of the script transformer 303 may take other forms as well.

Referring again to FIG. 3, as introduced above, the diagram generator 305 may receive the set of diagram source code 304 that is generated by the script transformer 303 and then function to generate the diagram 306 representing the BDD test script 302 based on the set of diagram source code 304. The diagram 306 that is generated by the diagram generator 305 based on the set of diagram source code 304 may generally comprise a visualization of the at least one behavioral scenario defined by the BDD test script 302, which may take any of various forms. For instance, as one possibility, the diagram 306 that is generated by the diagram generator 305 based on the set of diagram source code 304 may comprise a sequence diagram that visualizes the at least one behavioral scenario defined by the BDD test script 302 in terms of a sequence of interactions between entities involved in the at least one behavioral scenario over time and perhaps also notes that provide additional information regarding particular interactions and/or entities.

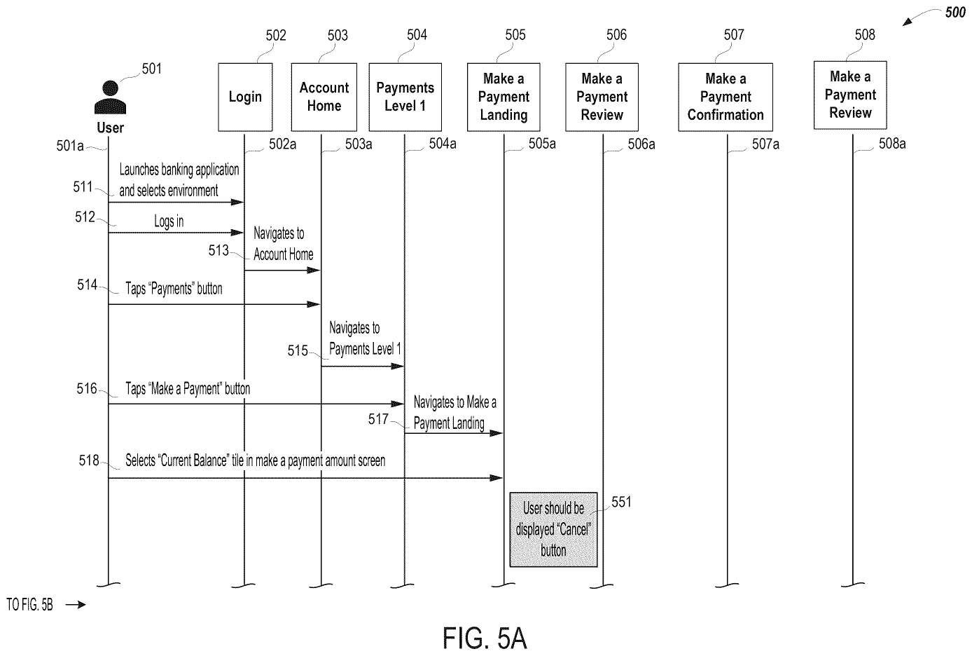

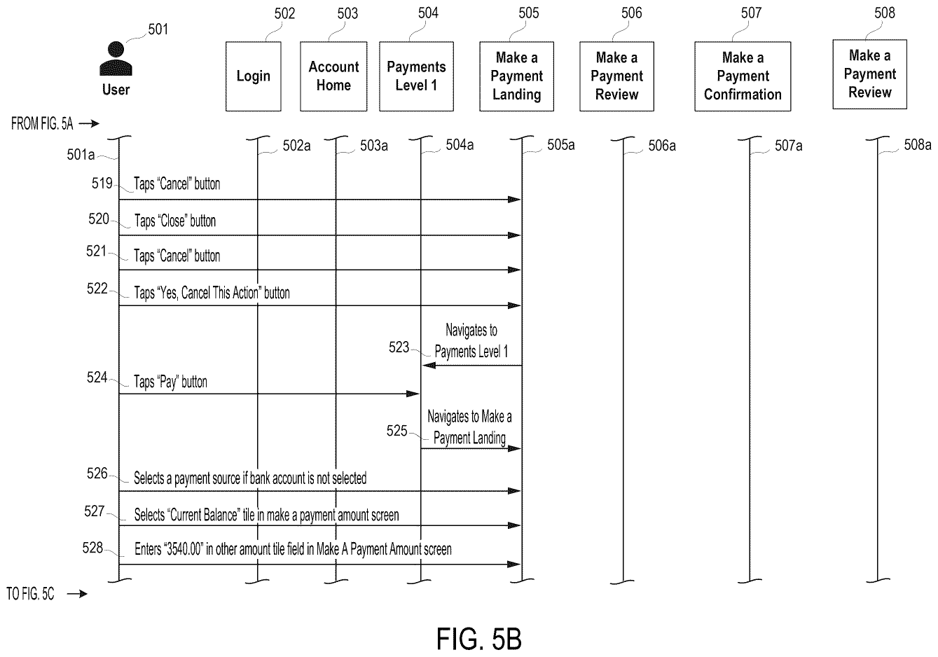

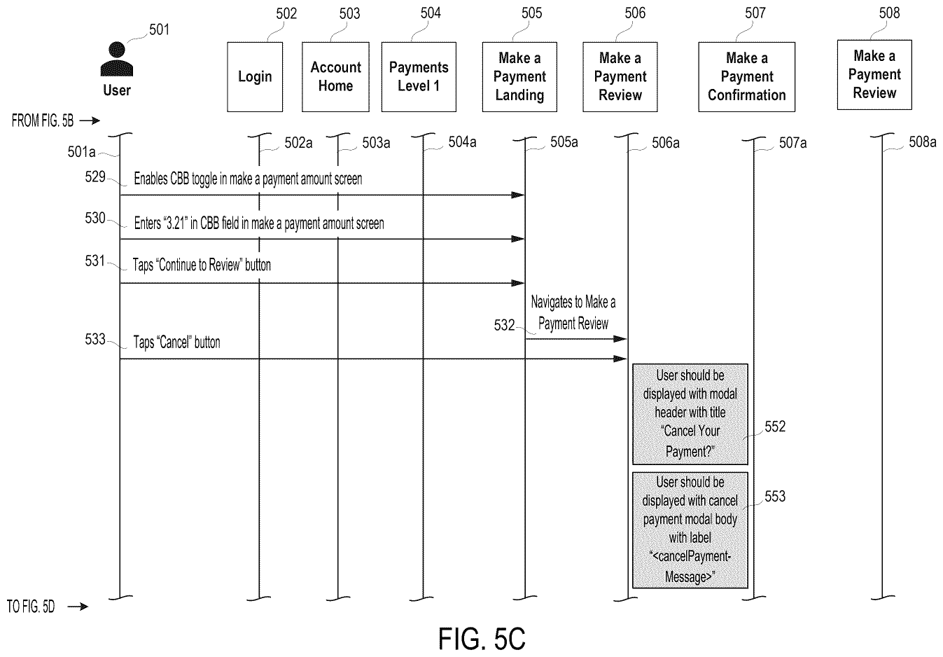

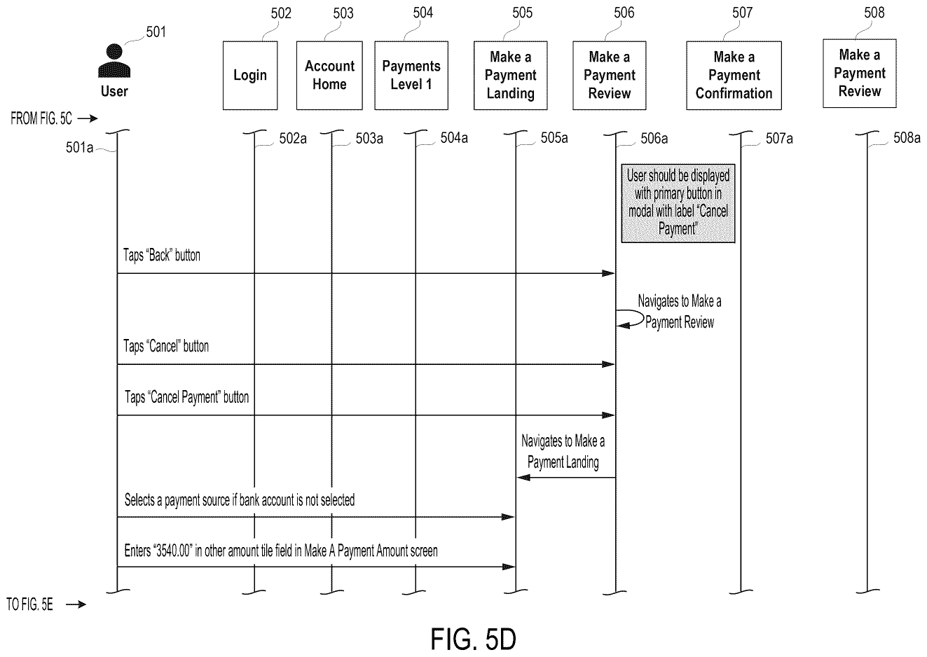

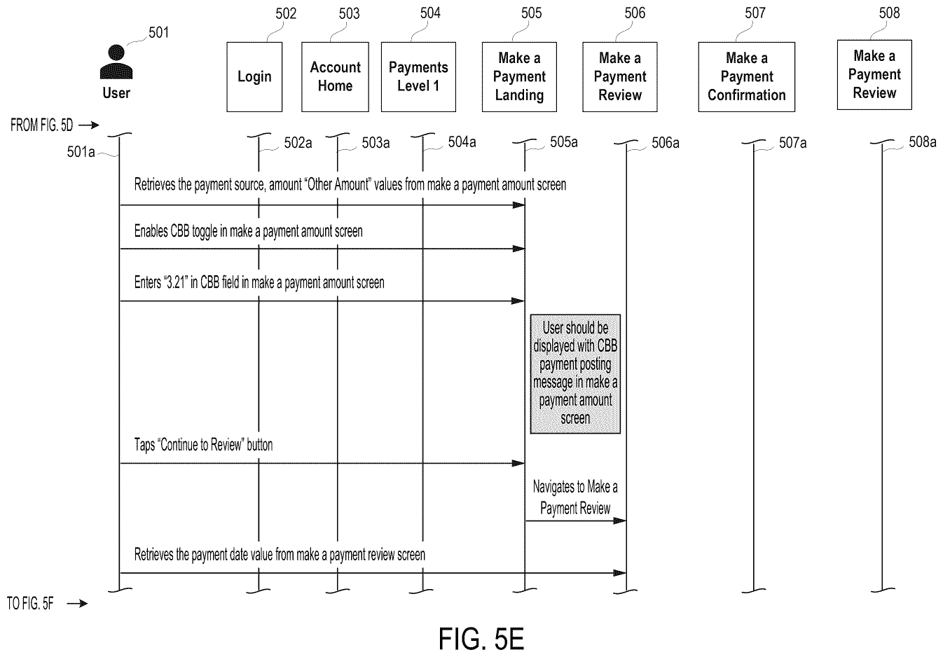

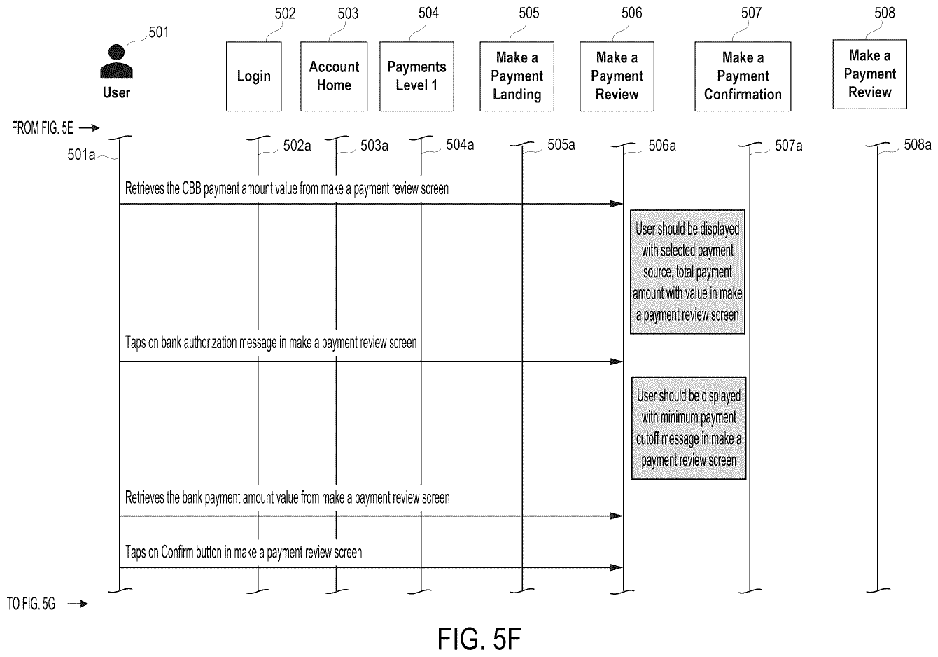

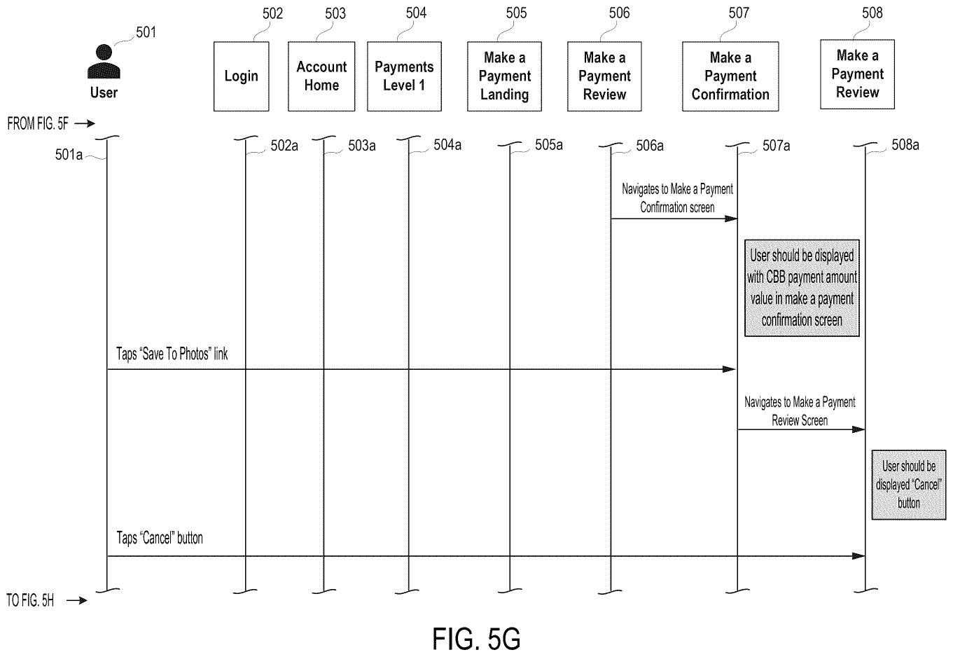

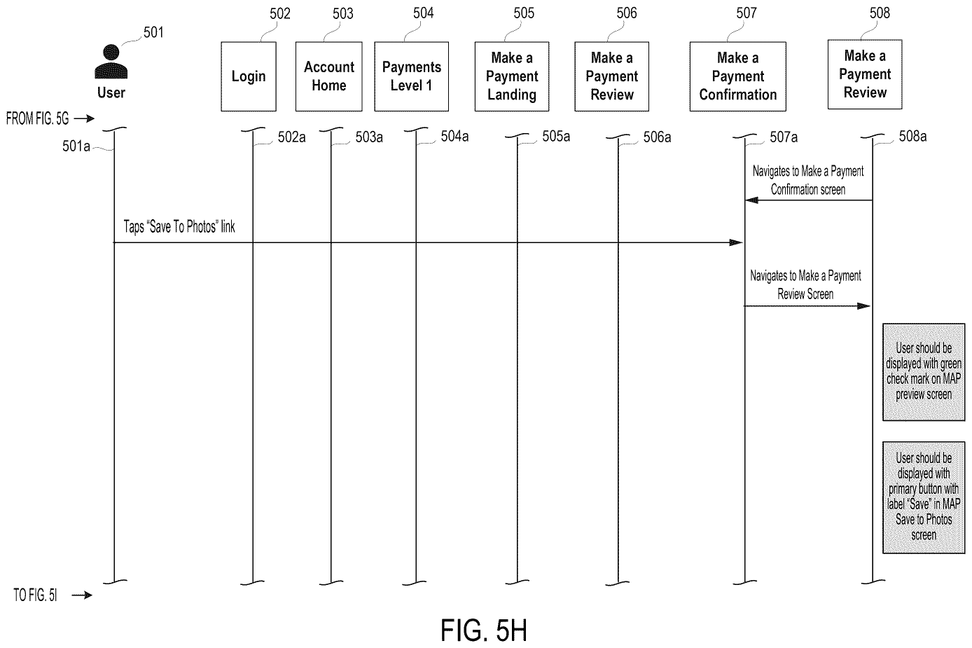

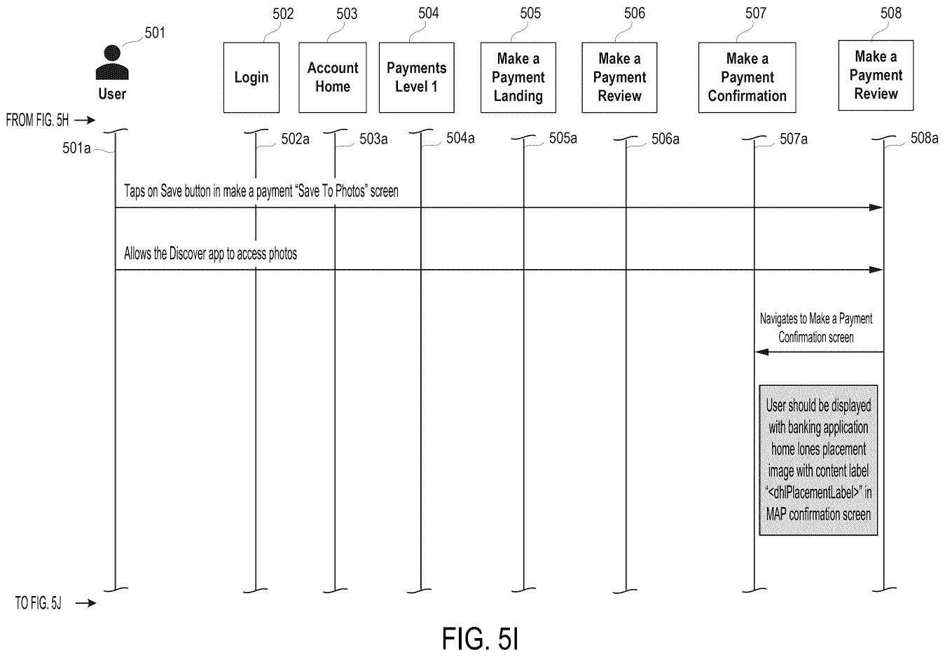

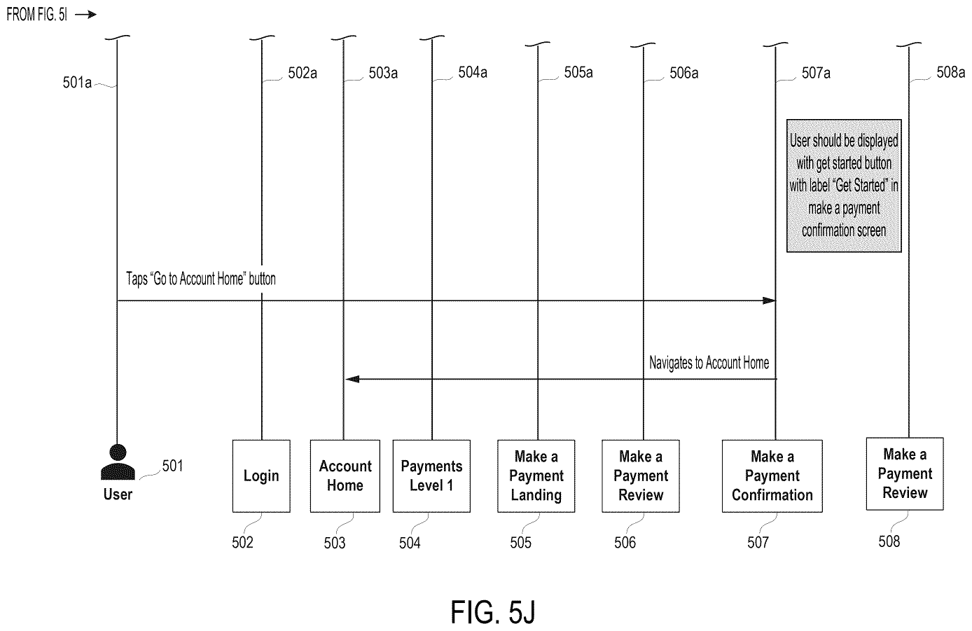

FIGS. 5A-5J collectively provide one illustrative example of a sequence diagram 500 representing the example BDD test script 100 shown in FIG. 1 that may be generated by the diagram generator 305 based on the example set of Mermaid source code 400 shown in FIG. 4. It should be understood that the respective portion of the sequence diagram 500 that is shown in each of FIGS. 5A-5J may comprise only a portion of a sequence diagram that may be generated by the diagram generator 305 based on the example set of Mermaid source code 400 shown in FIG. 4 and may include additional entities and interactions that are not shown in FIGS. 5A-5J.

As shown in FIGS. 5A-5J, the example sequence diagram 500 includes visual representations of the entities involved in the behavioral scenario defined by the example BDD test script 100 across the top of the diagram, where each such visual representation takes the form of either an “actor” icon (with a text label underneath) to denote that the entity is specifically defined as an actor (e.g., a user of the software application) or a text box (with a text label inside indicating a particular software component of the banking software application), among other possible types of visual representations of the entities.

More particularly, the example sequence diagram 500 includes a first visual representation 501 of the user of the banking software application (which takes the form of an actor icon), a second visual representation 502 of the “Login” screen component of the banking software application (which takes the form of a text box having a “Login” text label), a third visual representation 503 of the “Account Home” screen component of the banking software application (which takes the form of a text box having an “Account Home” text label), a fourth visual representation 504 of the “Payments Level 1” screen component of the banking software application (which takes the form of a text box having an “Payments Level 1” text label), a fifth visual representation 505 of the “Make a Payment Landing” screen component of the banking software application (which takes the form of a text box having a “Make a Payment Landing” text label), a sixth visual representation 506 of the “Make a Payment Review” screen component of the banking software application (which takes the form of a text box having a “Make a Payment Review” text label), a seventh visual representation 507 of the “Make a Payment Confirmation” screen component of the banking software application (which takes the form of a text box having a “Make a Payment Confirmation” text label), and an eighth visual representation 508 of the “Make a Payment Review” screen component of the banking software application (which takes the form of a text box having a “Make a Payment Review” text label).

Further, as shown in FIGS. 5A-5J, each visual representation of a respective entity may have an associated lifeline that comprises a vertical line extending downwardly from the visual representation. For instance, the first visual representation 501 of the user has an associated lifeline 501a, the second visual representation 502 of the “Login” screen component has an associated lifeline 502a, the third visual representation 503 of the “Account Home” screen component has an associated lifeline 503a, the fourth visual representation 504 of the “Payments Level 1” screen component has an associated lifeline 504a, the fifth visual representation 505 of the “Make a Payment Landing” screen component has an associated lifeline 505a, the sixth visual representation 506 of the “Make a Payment Review” screen component has an associated lifeline 506a, the seventh visual representation 506 507 of the “Make a Payment Confirmation” screen component has an associated lifeline 507a, and the eighth visual representation 508 of the “Make a Payment Review” screen component has an associated lifeline 508a.

Further yet, as shown in FIGS. 5A-5J, each respective interaction between two entities may be represented by a horizontal arrow that extends from a first lifeline of the initiating entity of the interaction to a second lifeline of the target entity of the interaction, accompanied by a text label that includes the subject of the interaction. For instance, the respective portions of the sequence diagram 500 shown in FIGS. 5A-5C depicts a sequence of interactions 511-533 each represented by a horizontal arrow extending from the lifeline of the initiating entity of the interaction to the lifeline of the target entity of the interaction, accompanied by text describing the subject of the interaction.

To illustrate with an example, an interaction 511 between the user and the “Login” component may be represented by a horizontal arrow that extends from the lifeline 501a associated with the visual representation 501 of the user to the lifeline 502a associated with the visual representation 502 of the “Login” component, accompanied by a text label “Launches banking software application and selects environment” describing the subject of the interaction between the user and the “Login” component of the banking software application.

To illustrate with another example, an interaction 513 between the “Login” component and the “Account Home” component of the banking software application may be represented by a horizontal arrow that extends from the lifeline 502a associated with the visual representation 502 of the “Login” component to the lifeline 503a associated with the visual representation 503 of the “Account Home” component, accompanied by a text label “Navigates to Account Home” describing the subject of the interaction between the “Login” component and the “Account Home” component of the banking software application.

To illustrate with yet another example, an interaction 518—which corresponds to interaction line 11 of the example Mermaid source code 400 shown in FIG. 4 that takes the form of “User->>Make a Payment Landing: Selects “Current Balance” tile in make a payment amount screen” indicating an interaction where (i) the initiating entity comprises the user of the banking software application, (ii) the target entity comprises the “Make a Payment Landing” screen of the banking software application, (iii) the directionality of the interaction flows from the user to the “Make a Payment Landing” screen, and (iv) the subject of the interaction comprises the text “Selects “Current Balance” tile in make a payment amount screen”—may be represented by a horizontal arrow that extends from the lifeline 501a associated with the visual representation 501 of the user of the banking software application to the lifeline 505a associated with the visual representation 505 of the “Make a Payment Landing” component, accompanied by a text label “Selects ‘Current Balance’ tile in make a payment amount screen” describing the subject of the interaction between the user and the “Make a Payment Landing” component of the banking software application.

Interactions 512, and 514-533 corresponding to respective interaction lines of the example Mermaid source code 400 shown in FIG. 4 may have a similar form.

Still further, as shown in FIGS. 5A-5J, each respective note that provides additional information regarding a particular interaction and/or particular entity may be represented by a respective visual representation, such as a floating text box, that contains text describing the subject of the interaction and is located at a position within the example sequence diagram 500 that indicates some relationship to a particular interaction and/or a particular entity involved in the behavioral scenario defined by the example BDD test script 100. For instance, a visual representation of a note that is related to a particular interaction between two entities may be located at (i) a vertical position that is at or below the vertical position of the horizontal arrow that represents the particular interaction and (ii) a horizontal position that is to the left or right of the lifeline for one of the entities involved in the interaction, among other possible locations of a visual representation of a note.

To illustrate with an example, FIG. 5A depicts a note 551 represented by a floating text box that contains text which reads “User should be displayed ‘Cancel’ button” and is located vertically below horizontal arrow 518 and horizontally to the right of lifeline 505a. Further, the text of the note 551 may be broken up into two or more lines in accordance with the example Mermaid source code 400 shown in FIG. 4 (e.g., line 12 indicating a line break “<br/>”). In this respect, the spacing and/or scaling of text that accompanies the sequence diagram (e.g., text accompanying horizontal arrows or text contained within floating text boxes) may be adjusted depending on various factors, such as the type of device on which the sequence diagram is displayed (e.g., laptop, smart phone, smart watch, etc.), which may require the text to be displayed different sizes, resolutions, and the like. For example, based on the line break indicated in line 12 of the example Mermaid source code 400 shown in FIG. 4, the note 551 should include two lines of text, with the first line reading “User should be” and the second line reading “displayed ‘Cancel’ button”. However, in the example shown in FIG. 5A, the text of the note 551 is broken up into three lines of text, with the first line reading “User should be,” the second line reading “displayed ‘Cancel’,” and the third line reading “button,” and is located vertically below horizontal arrow 518 and horizontally to the right of lifeline 505a.

To illustrate with another example, FIG. 5C depicts a note 552 represented by a floating text box that contains text reading “User should be displayed with modal header with title “Cancel Your Payment?’”—which, in this example, is displayed across four lines of text, with the first line reading “User should be displayed,” the second line reading “with modal header with,” the third line reading “title ‘Cancel Your’,” and the fourth line reading “‘Payment?’”—and is located vertically below horizontal arrow 533 and to the right of lifeline 506a, and a note 553 represented by a floating text box that contains text reading “User should be displayed with cancel payment modal body with label ‘<cancelPayment-Message>”—which, in this example, is displayed across five lines of text, with the first line reading “User should be displayed,” the second line reading “with cancel payment,” the third line reading “modal body with label,” the fourth line reading “‘<cancelPayment-’,” and the fifth line reading “Message>’”—and is located vertically below the note 552 and to the right of lifeline 506a. Other notes in the sequence diagram 500 shown throughout FIG. 5A-5J may have a similar form.

Returning to FIG. 3, the diagram 306 may take other forms as well, including but not limited to the possibility that the diagram 306 could be in the form of a flow chart, a Gantt chart, a state diagram, a swimlane diagram, or the like.

The functionality that is carried out by the diagram generator 305 in order to generate the diagram 306 based on the set of diagram source code 304 may take any of various forms. In general, this functionality may involve parsing diagram syntax of the diagram source code 304 and generating (i) a respective actor icon and lifeline for each “actor” entity described in the diagram syntax, (ii) a respective rectangle and lifeline for each software component entity described in the diagram syntax, (iii) for each interaction involving two entities, a horizontal arrow between the respective lifelines of the two entities, along with text describing the subject of the interaction, and (iv) for each note associated with a particular interaction and/or entity, a respective floating rectangle that describes the subject of the note and is located in a particular location relative to the particular interaction and/or entity.

For instance, as one example, based on parsing diagram syntax in interaction line 3 of the example Mermaid source code 400 shown in FIG. 4 describing an interaction that takes the form of “User->>Login: Launches banking software application and selects environment,” the diagram generator 305 may identify an interaction where (i) the initiating entity comprises a user of the banking software application, (ii) the target entity comprises a “Login” screen of the banking software application, (iii) the directionality of the interaction flows from the user to the “Login” screen, and (iv) the subject of the interaction comprises the text “Launches banking software application and selects environment.” In turn, the diagram generator 305 may determine that the interaction described in interaction line 3 should be represented in the form of, and may thereby generate, (i) the visual representation 501 and associated lifeline 501a for the user, (ii) the visual representation 502 and associated lifeline 502a for the “Login” component, and (iii) a horizontal arrow 511 extending from the lifeline 501a to the lifeline 502a, accompanied by a text label “Launches banking software application and selects environment,” as shown in FIG. 5.

As another example, based on parsing diagram syntax in interaction line 6 of the example Mermaid source code 400 shown in FIG. 4 describing an interaction that takes the form of “Login->>Account Home: Navigates to Account Home,” the diagram generator 305 may identify an interaction where (i) the initiating entity comprises the “Login” screen of the banking software application, (ii) the target entity comprises the “Account Home” screen of the banking software application, (iii) the directionality of the interaction flows from the “Login” screen to the “Account Home” screen, and (iv) the subject of the interaction comprises the text “Navigates to Account Home.” In turn, the diagram generator 305 may determine that the interaction described in interaction line 3 should be visually represented in the form of, and may thereby generate, (i) the visual representation 502 and associated lifeline 502a for the “Login” component, (ii) the visual representation 503 of the “Account Home” component, and (iii) a horizontal arrow 513 extending from the lifeline 502a to the lifeline 503a, accompanied by a text label “Navigates to Account Home,” as shown in FIG. 5.

As yet another example, based on parsing diagram syntax in note line 12 of the example Mermaid source code 400 shown in FIG. 4 describing a note that takes the form of “Note right of Make a Payment Landing: User should be <br/> displayed ‘Cancel’ button,” the diagram generator 305 may identify a note that (i) contains two lines of text reading “User should be <br/> displayed ‘Cancel’ button” (where <br/> indicates a line break) and (ii) is located vertically to the right of lifeline 505a for the “Make a Payment Landing” component. In turn, the diagram generator 305 may determine that the note is to be visually represented in the form of, and may thereby generate, the floating text box 551 containing the text “User should be displayed ‘Cancel’ button,” as shown in FIG. 5A.

As yet another example, based on parsing diagram syntax in note line 28 of the example Mermaid source code 400 shown in FIG. 4 describing a note that takes the form of “Note right of Make a Payment Review: User should be <br/> displayed with modal <br/> header with title <br/> ‘Cancel Your Payment?” may identify a note that (i) contains four lines of text reading “User should be <br/> displayed with modal <br/> header with title <br/> ‘Cancel Your Payment?’” (where <br/> indicates a line break) and (ii) is located vertically to the right of lifeline 506a for the “Make a Payment Review” component. In turn, the diagram generator 305 may determine that the note is to be visually represented in the form of, and may thereby generate, the floating text box 552 containing the text “User should be displayed with modal header with title ‘Cancel Your Payment?’” as shown in FIG. 5C.

The diagram generator 305 may parse each other line in the example Mermaid source code 400 in a similar manner. Based on parsing the example Mermaid source code 400, the diagram generator 305 may generate the sequence diagram 500.

The functionality of generating the sequence diagram 306 based on the diagram source code 304 may take other forms as well. Further, while the examples above with respect to generating diagram source code and a corresponding graphical representation are discussed in the context of Mermaid code and a corresponding sequence diagram, it should be understood that the diagram source code 304 may take other forms, and that a diagram that is generated by the diagram generator 305 based on the diagram source code 304 may take any of various forms depending on the syntax of the diagram source code 304. For instance, in some embodiments, the graphical representation may take the form of a UML diagram. Other examples are also possible.

The functionality of generating the sequence diagram 306 based on the diagram source code 304 may take other forms as well. Further, while the examples above with respect to generating diagram source code and a corresponding graphical representation are discussed in the context of Mermaid code and a corresponding sequence diagram, it should be understood that the diagram source code 304 may take other forms, and that a diagram that is generated by the diagram generator 305 based on the diagram source code 304 may take any of various forms depending on the syntax of the diagram source code 304.

After the sequence diagram 306 has been generated by the diagram generator 305, the computing system 300 may cause the sequence diagram 306 to be presented to a user. Depending on the embodiment, the function of causing the sequence diagram 306 to be presented to a user may take various forms. For instance, in an embodiment where the computing system 300 takes the form of a client device, the function of causing the sequence diagram 306 to be presented to a user may involve the client device displaying, via a user interface of the client device, a GUI view comprising the sequence diagram 306. Alternatively, in an embodiment where the computing system 300 comprises a back-end computing platform and a client device, the function of causing the sequence diagram 306 to be presented to a user may involve either (i) the back-end computing platform transmitting the diagram source code 304 to the client device and the client device then generating the diagram 306 based on the diagram source code 304 and displaying the diagram 306 to the user via the client device's user interface (in which case the script transformer 303 may run on the back-end platform and the diagram generator 305 may run on the client device) or (ii) the back-end computing platform generating the diagram 306 based on the diagram source code 304 and sending a representation of the generated diagram 306 to the client device and the client device then displaying the diagram 306 to the user via the client device's user interface (in which case the script transformer 303 and the diagram generator 305 may both run on the back-end platform). Other examples are also possible.

Additionally, the example software-based pipeline 301 may optionally store the set of diagram source code 304 and/or a representation of the generated diagram 306 for future reference (e.g., within a data storage layer of the computing system 300).

In practice, the functionality of the example software-based pipeline 301 could be carried out at any of various times and in response to any of various trigger events. For instance, as one possibility, the functionality of the example software-based pipeline 301 could be carried out in response to user input, such as a user inputting a request to transform a given BDD test script into a diagram. As another possibility, the functionality of the example software-based pipeline 301 could be carried out in response to detecting that there has been a change to a given BDD test script (e.g., a BDD test script that was previously transformed by the example software-based pipeline 301). Other examples are possible as well.

The example software-based pipeline 301 described above could also take other forms. For instance, as one possibility, the example software-based pipeline 301 may include other components that are not shown or described above but may nevertheless facilitate the functionality disclosed herein. As another possibility, certain of the components shown and described above could be combined together or separated out into multiple sub-components. As yet another possibility, certain of the components shown and described above may perform additional or different functionality from what is described above. Other variations of the example software-based pipeline 301 are possible as well.

Further, as noted above, it is possible that the functionality of the example software-based pipeline 301 could be distributed across multiple different computing units. For instance, in a scenario where the example software-based pipeline 301 is implemented as part of a client-service application, the script transformer 303 could run on the back-end platform and the diagram generator 305 could run on the client device. Other distributed arrangements of the functionality of the example software-based pipeline 301 are possible as well.

The disclosed software technology may also include a graphical user interface (GUI) that enables a user to interact with the example software-based pipeline 301, which may include functionality for (i) receiving a user's input of a BDD test script to be transformed into a diagram and (ii) presenting the diagram representing the BDD test script to the user.

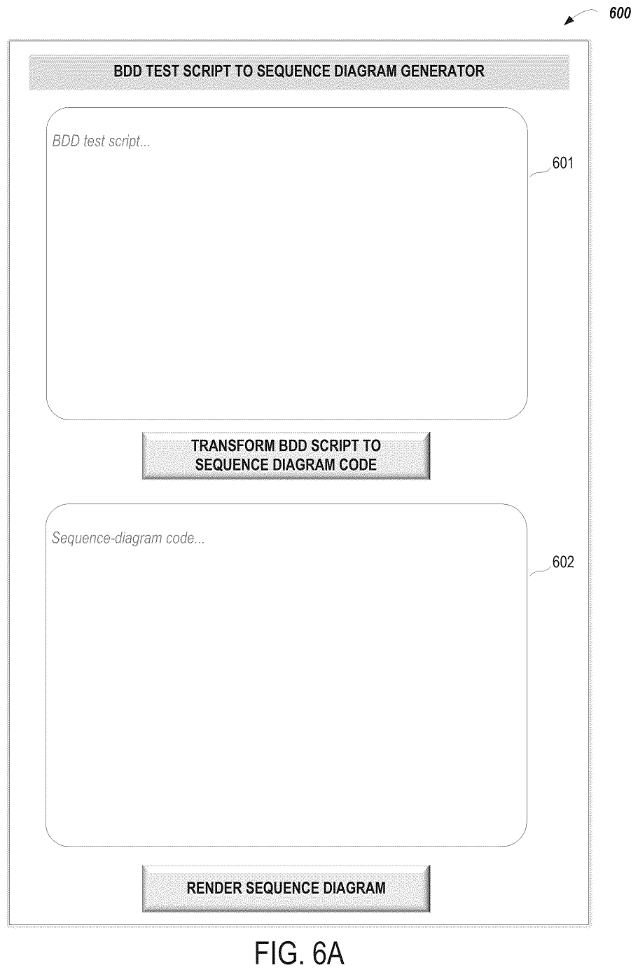

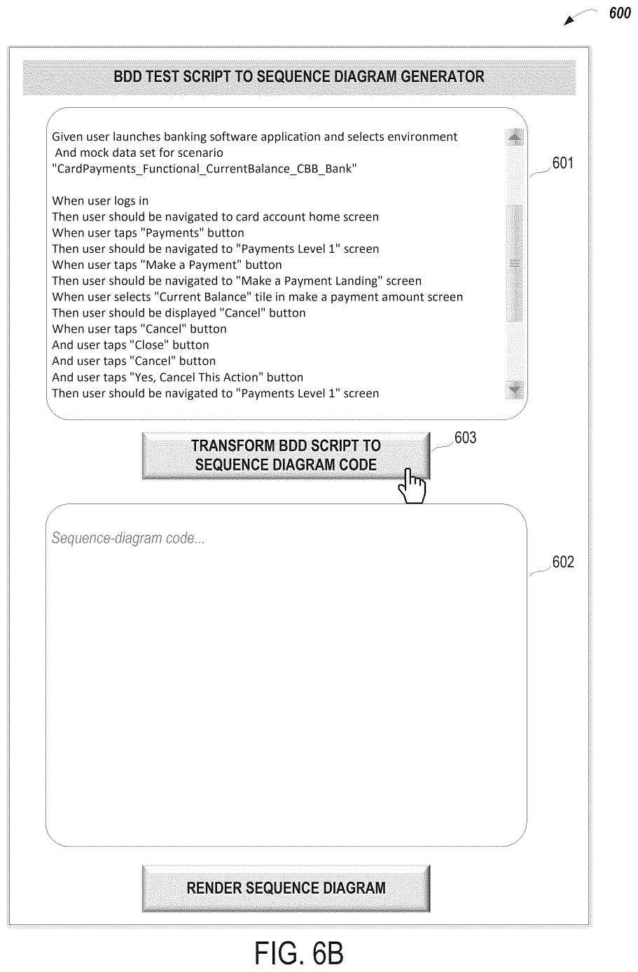

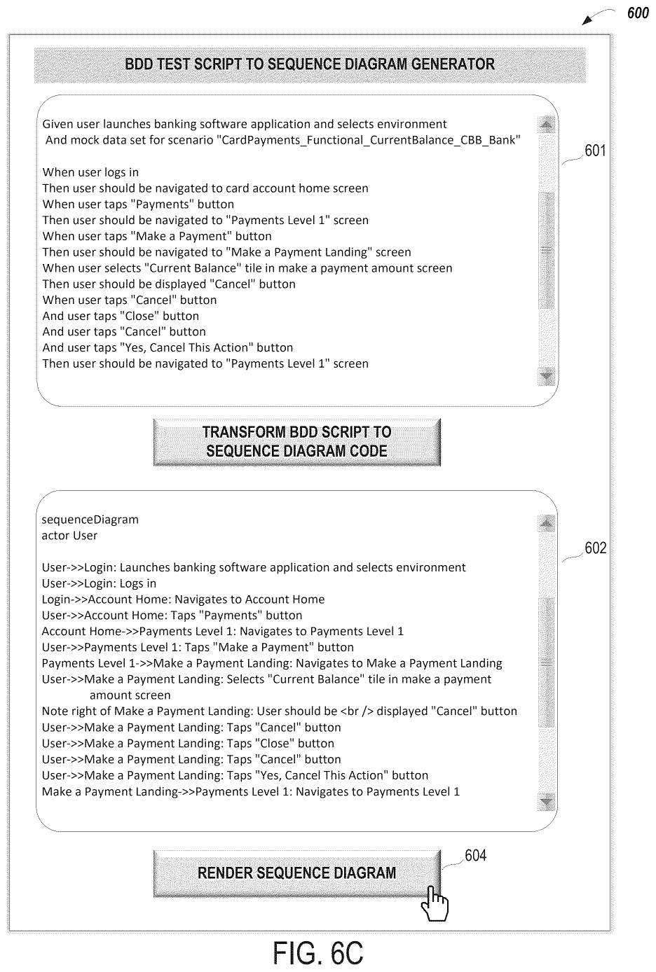

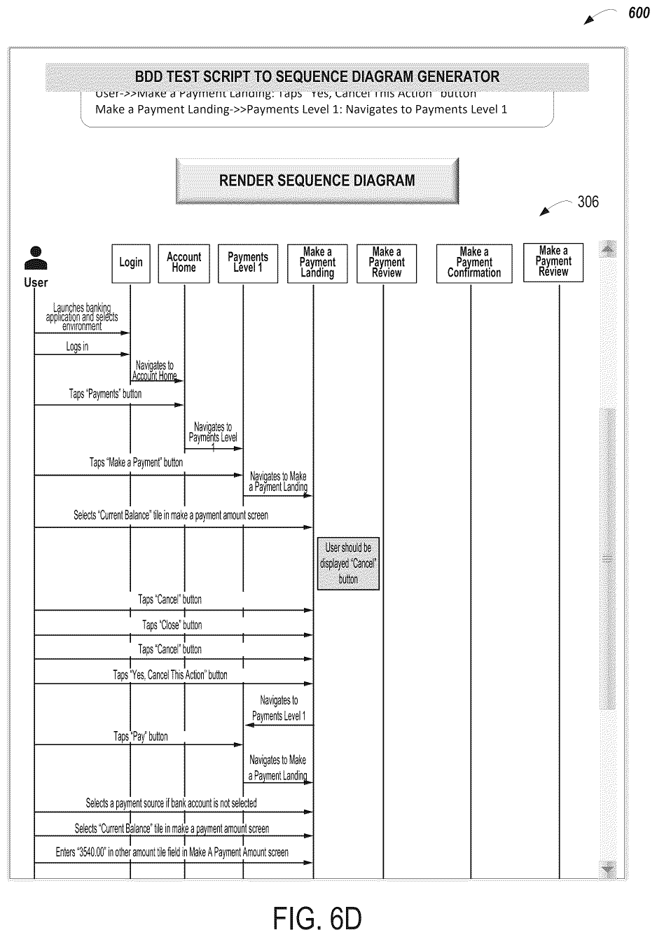

FIGS. 6A-6D depict some examples of GUI views that may be displayed to a user in an embodiment where the software-based pipeline 301 is installed on and executed by a computing system 300 that comprises a client device, such as a client device 202 as shown in FIG. 2. In such an embodiment, in practice, a user may access, via the client device 202, a software application that comprises the disclosed software technology and navigate to a GUI view for transforming BDD test scripts into sequence diagrams. In turn, the software-based pipeline 301 may cause the client device 202 to display a GUI view 600 as shown in FIG. 6A. The GUI view 600 may comprise a data field 601 for receiving a BDD test script and a data field 602 for receiving and/or displaying diagram sequence code. For instance, as shown in FIG. 6B, the user may enter a BDD test script 302 in the data field 601, such as by pasting the contents of the BDD test script 302 in the data field 601. Although not shown in FIG. 6B, the GUI view 600 may also include an option for importing a BDD test script, based on which the user may upload a file comprising a BDD test script (e.g., a feature file, etc.). Other options for inputting the BDD test script 302 in the data field 601 are also possible.

In any event, after providing the BDD test script 302, the user may select an option to transform the BDD test script into sequence diagram code. For instance, the user may select an option 603 to “TRANSFORM BDD TEST SCRIPT TO SEQUENCE DIAGRAM CODE,” based on which the software-based pipeline 301 may cause the BDD test script to be provided as input to the script transformer 303. In line with the discussion above, the 3ay transform the BDD test script 302 into diagram source code 304. In turn, the software-based pipeline 301 may cause the client device 202 to update the GUI view 600 to display the diagram source code 304.

For instance, as shown in FIG. 6C, the data field 602 may be updated to display the diagram source code 304 that was generated based on the BDD test script 302. In turn, the user may select an option to generate a sequence diagram based on the diagram source code 304. For instance, as shown in FIG. 6C, the user may select option 604 to “RENDER SEQUENCE DIAGRAM,” based on which the software-based pipeline 301 may cause the diagram source code 304 to be provided as input to the diagram generator 305. In line with the discussion above, based on the diagram source code 304, the diagram generator 305 may generate a sequence diagram 306 and cause the sequence diagram 306 to be displayed to the user. For instance, based on generating the sequence diagram 306, the client device may update the GUI view 600 to display the sequence diagram 306. For instance, as shown in FIG. 6D, the client device may display at least a portion of the sequence diagram 306, including a GUI component that enables the user to scroll up and/or down to view the sequence diagram 306. Although not shown in FIG. 6D, the view 600 may include other options as well, such as an option to download or export or the sequence diagram.

The GUI views that may be presented to a user based on implementing the software-based pipeline 301 may take other forms as well.

The sequence diagram 306 may then be reviewed by the user (and any one or more other individuals) to determine if the BDD test script 302 requires any revisions before being implemented for testing software functionality.

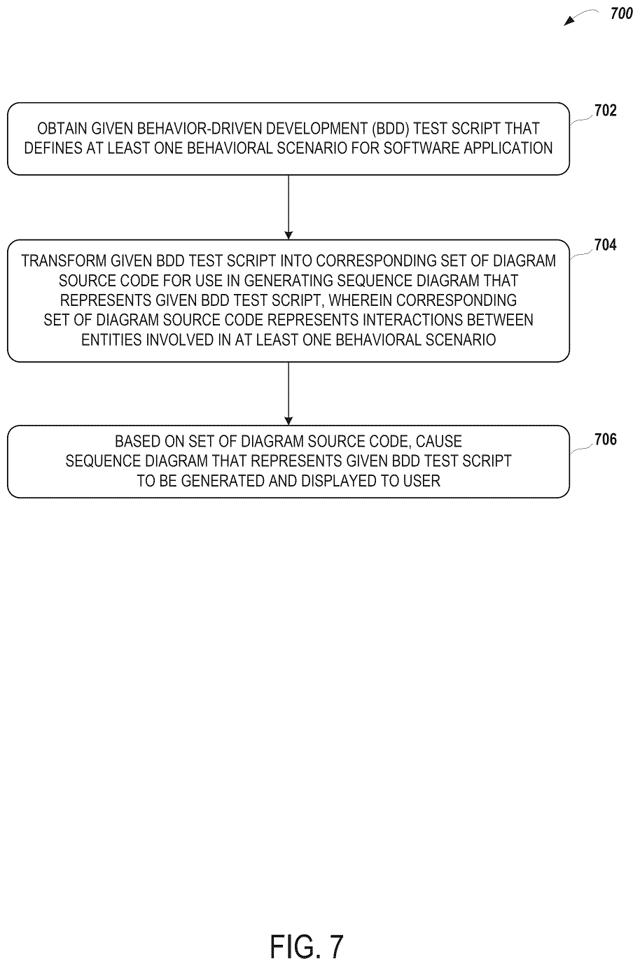

One possible example of functionality 700 that may be carried out in accordance with the disclosed technology will now be described with reference to the flow chart of FIG. 7. In practice, the functionality 700 of FIG. 7 may be encoded in the form of program instructions that are executable by one or more processors of a computing system, and for purposes of illustration, the functionality 700 of FIG. 7 is described as being carried out by the computing system 300 of FIG. 3, but it should be understood that the functionality 700 of FIG. 7 may be carried out by any one or more computing system that are capable of being installed with software for performing the functions described below. Further, it should be understood that the functionality 700 of FIG. 7 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

The functionality 700 may begin at 702, where the computing system 300 may obtain a given BDD test script that defines at least one behavioral scenario for a software application. In accordance with the discussion above, the given BDD test script may be received as input by a particular component of the computing system 300 (e.g., the script transformer 303), and may take various forms, one example of which may comprise a BDD test script created using a Gherkin syntax.

In turn, at 704, the computing system 300 may transform the given BDD test script into a corresponding set of diagram source code for use in generating a diagram (e.g., a sequence diagram) that represents the given BDD test script. In accordance with the discussion above, this functionality involve a parsing process during which the computing system 300 parses each respective line of the given BDD test script (or at least each of a subset of lines of the given BDD test script) in order to (i) determine whether the respective line satisfies a transformation rule and (ii) if so, transform the respective line of the given BDD test script into a corresponding line that is to be added to the set of diagram source code.

After transforming the given BDD test script and thereby generating the set of diagram source code, at 706, based on the set of diagram source code, the computing system 300 may cause the diagram that represents the given BDD test script to be generated and displayed to a user, in accordance with the discussion above.

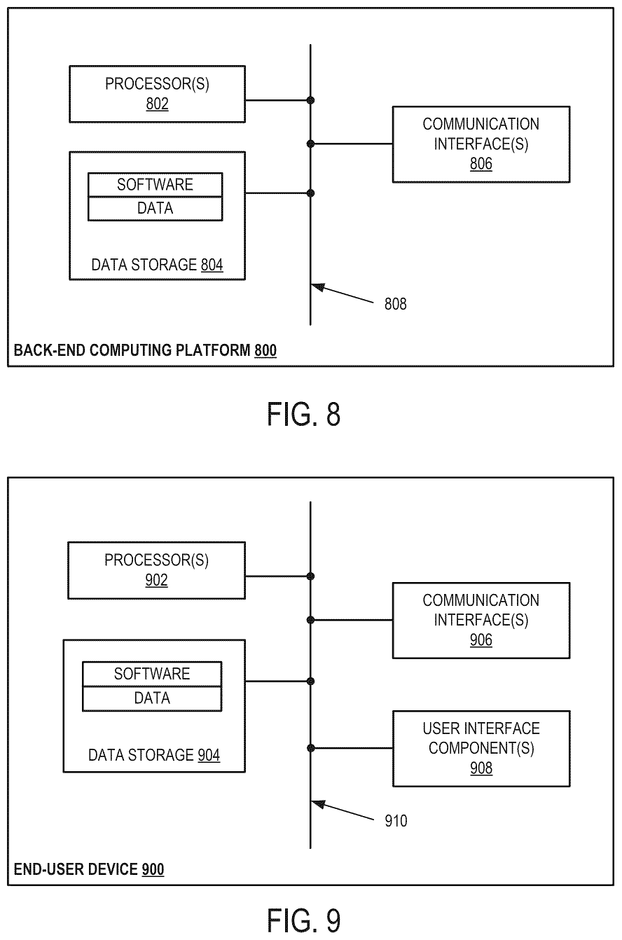

Turning now to FIG. 8, a simplified block diagram is provided to illustrate some structural components that may be included in an example back-end computing platform 800 that may be configured to carry out any of the various back-end functionality disclosed herein. At a high level, the example back-end computing platform 800 may generally comprise any one or more computing systems that collectively include one or more processors 802, data storage 804, and one or more communication interfaces 806, all of which may be communicatively linked by a communication link 808 that may take the form of a system bus, a communication network such as a public, private, or hybrid cloud, or some other connection mechanism. Each of these components may take various forms.

The one or more processors 802 may each comprise one or more processing components, such as general-purpose processors (e.g., a single- or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. In line with the discussion above, it should also be understood that the one or more processors 802 could comprise processing components that are distributed across a plurality of physical computing systems connected via a network.

In turn, the data storage 804 may comprise one or more non-transitory computer-readable storage mediums that are collectively configured to store (i) program instructions that are executable by one or more processors 802 such that back-end computing platform 800 is configured to perform any of the various functions disclosed herein, and (ii) data that may be received, derived, or otherwise stored, for example, in one or more databases, file systems, repositories, or the like, by back-end computing platform 800, in connection with performing any of the various functions disclosed herein. In this respect, the one or more non-transitory computer-readable storage mediums of the data storage 804 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing systems connected via a network.

The one or more communication interfaces 806 may be configured to facilitate wireless and/or wired communication with other systems and/or devices, such as client devices (e.g., one or more client devices 202 of FIG. 2, one or more client devices 900 of FIG. 9). Additionally, in an implementation where the back-end computing platform 800 comprises a plurality of physical computing systems connected via a network, the one or more communication interfaces 806 may be configured to facilitate wireless and/or wired communication between these physical computing systems (e.g., between computing and storage clusters in a cloud network). As such, the one or more communication interfaces 806 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the back-end computing platform 800 may additionally include or have an interface for connecting to one or more user-interface components that facilitate user interaction with the back-end computing platform 800, such as a keyboard, a mouse, a trackpad, a display screen, a touch-sensitive interface, a stylus, a virtual-reality headset, and/or one or more speaker components, among other possibilities.

It should be understood that the back-end computing platform 800 is one example of a computing platform that may be used with the embodiments described herein. Numerous other arrangements are possible and contemplated herein. For instance, in other embodiments, the back-end computing platform 800 may include additional components not pictured and/or more or fewer of the pictured components.

Turning next to FIG. 9, a simplified block diagram is provided to illustrate some structural components that may be included in an example client device 900. As shown in FIG. 8, the client device 900 may include one or more processors 902, data storage 904, one or more communication interfaces 906, and one or more user-interface components 908, all of which may be communicatively linked by a communication link 910 that may take the form of a system bus or some other connection mechanism. Each of these components may take various forms.

The one or more processors 902 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 904 may comprise one or more non-transitory computer-readable storage mediums that are collectively configured to store (i) program instructions that are executable by the processor(s) 902 such that the client device 900 is configured to perform certain functions related to interacting with and accessing services provided by a computing platform, and (ii) data that may be received, derived, or otherwise stored, for example, in one or more databases, file systems, repositories, or the like, by the client device 900, related to interacting with and accessing services provided by a computing platform. In this respect, the one or more non-transitory computer-readable storage mediums of the data storage 904 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 904 may take other forms and/or store data in other manners as well.

The one or more communication interfaces 906 may be configured to facilitate wireless and/or wired communication with other computing devices. The communication interface(s) 906 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The client device 900 may additionally include or have interfaces for one or more user-interface components 908 that facilitate user interaction with the client device 900, such as a keyboard, a mouse, a trackpad, a display screen, a touch-sensitive interface, a stylus, a virtual-reality headset, and/or one or more speaker components, among other possibilities.

It should be understood that the client device 900 is one example of a client device that may be used to interact with an example computing platform as described herein. Numerous other arrangements are possible and contemplated herein. For instance, in other embodiments, the client device 900 may include additional components not pictured and/or more or fewer of the pictured components.

### CONCLUSION

This disclosure makes reference to the accompanying figures and several example embodiments of the disclosed innovations that have been described above. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

1. A computing system comprising:
at least one processor;
at least one non-transitory computer-readable medium; and
program instructions stored on the at least one non-transitory computer-readable medium that, when executed by the at least one processor, cause the computing system to:
obtain a given behavior-driven development (BDD) test script that defines at least one behavioral scenario for a software application;
transform the BDD test script into a corresponding set of diagram source code for use in generating a sequence diagram that represents the given BDD test script, wherein the corresponding set of diagram source code represents interactions between entities involved in the at least one behavioral scenario; and
based on the set of diagram source code, cause the sequence diagram that represents the given BDD test script to be generated and displayed to a user.

2. The computing system of claim 1, wherein the program instructions that, when executed by the at least one processor, cause the computing system to obtain the BDD test script further comprise program instructions that, when executed by the at least one processor, cause the computing system to:
cause the user to be presented with a user interface view for inputting a BDD test script that is to be represented as a diagram; and
receive the given BDD test script via the user interface view.

3. The computing system of claim 1, wherein:
the given BDD test script comprises a BDD test script that is created using Gherkin syntax;
the set of diagram source code comprises Mermaid code; and
the sequence diagram comprises a Mermaid sequence diagram.

4. The computing system of claim 1, wherein the set of diagram source code comprises:
a plurality of interaction lines that each represents a respective interaction in terms of (i) an initiating entity for the respective interaction, (ii) a target entity for the respective interaction, and (iii) a subject of the respective interaction; and
a plurality of note lines that each represents a respective note in terms of (i) a location of the respective note within the sequence diagram and (ii) a subject of the respective note.

5. The computing system of claim 1, wherein the program instructions that, when executed by the at least one processor, cause the computing system to transform the BDD test script into the corresponding set of diagram source code comprise program instructions that, when executed by the at least one processor, cause the computing system to:
parse the given BDD test script on a line-by-line basis, wherein the parsing of each given line of the given BDD test script involves either (i) transforming the given line into a corresponding line that is represented according to a syntax of the set of diagram source code or (ii) determining that the given line is to be skipped without transformation.

6. The computing system of claim 5, wherein transforming the given line being parsed into the corresponding line that is represented according to the syntax of the set of diagram source code comprises:
evaluating whether the given line being parsed satisfies any one of a set of transformation rules;
based on the evaluating, determining that the given line satisfies a given transformation rule from the set of transformation rules; and
in response to the determining, carry out a transformation action defined by the given transformation rule in order to transform the given line into the corresponding line that is represented according to the syntax of the set of diagram source code.

7. The computing system of claim 6, wherein determining that the given line satisfies the given transformation rule from the set of transformation rules comprises:
determining that the given line matches a pattern that is defined by the given transformation rule.

8. The computing system of claim 6, wherein the corresponding line that is represented according to the syntax of the set of diagram source code comprises one or more of (i) content from the given line being parsed, (ii) content that is predefined as part of the given transformation rule, or (iii) content that is inferred from the given BDD test script.

9. The computing system of claim 8, wherein the content that is inferred from the given BDD test script comprises an inference of which software component of the software application will be currently active at a point when the given line of the given BDD test script will be executed.

10. The computing system of claim 1, wherein the interactions between entities comprise:
one or more interactions between an end-user of the software application and a software component of the software application; and
one or more interactions between different software components of the software application.

11. A method carried out by a computing system, the method comprising:
obtaining a given behavior-driven development (BDD) test script that defines at least one behavioral scenario for a software application;
transforming the BDD test script into a corresponding set of diagram source code for use in generating a sequence diagram that represents the given BDD test script, wherein the corresponding set of diagram source code represents interactions between entities involved in the at least one behavioral scenario; and
based on the set of diagram source code, causing the sequence diagram that represents the given BDD test script to be generated and displayed to a user.

12. The method of claim 11, wherein obtaining the BDD test script further comprises:
causing the user to be presented with a user interface view for inputting a BDD test script that is to be represented as a diagram; and
receiving the given BDD test script via the user interface view.

13. The method of claim 11, wherein:
the given BDD test script comprises a BDD test script that is created using Gherkin syntax;
the set of diagram source code comprises Mermaid code; and
the sequence diagram comprises a Mermaid sequence diagram.

14. The method of claim 11, wherein the set of diagram source code comprises:
a plurality of interaction lines that each represents a respective interaction in terms of (i) an initiating entity for the respective interaction, (ii) a target entity for the respective interaction, and (iii) a subject of the respective interaction; and
a plurality of note lines that each represents a respective note in terms of (i) a location of the respective note within the sequence diagram and (ii) a subject of the respective note.

15. The method of claim 11, wherein transforming the BDD test script into the corresponding set of diagram source code comprises:
parsing the given BDD test script on a line-by-line basis, wherein the parsing of each given line of the given BDD test script involves either (i) transforming the given line into a corresponding line that is represented according to a syntax of the set of diagram source code or (ii) determining that the given line is to be skipped without transformation.

16. The method of claim 15, wherein transforming the given line being parsed into the corresponding line that is represented according to the syntax of the set of diagram source code comprises:
evaluating whether the given line being parsed satisfies any one of a set of transformation rules;
based on the evaluating, determining that the given line satisfies a given transformation rule from the set of transformation rules; and
in response to the determining, carry out a transformation action defined by the given transformation rule in order to transform the given line into the corresponding line that is represented according to the syntax of the set of diagram source code.

17. The method of claim 16, wherein determining that the given line satisfies the given transformation rule from the set of transformation rules comprises:
determining that the given line matches a pattern that is defined by the given transformation rule.

18. The method of claim 16, wherein the corresponding line that is represented according to the syntax of the set of diagram source code comprises one or more of (i) content from the given line being parsed, (ii) content that is predefined as part of the given transformation rule, or (iii) content that is inferred from the given BDD test script.

19. The method of claim 18, wherein the content that is inferred from the given BDD test script comprises an inference of which software component of the software application will be currently active at a point when the given line of the given BDD test script will be executed.

20. A non-transitory computer-readable medium, wherein the non-transitory computer-readable medium is provisioned with program instructions that, when executed by at least one processor, cause a computing system to:
obtain a given behavior-driven development (BDD) test script that defines at least one behavioral scenario for a software application;
transform the BDD test script into a corresponding set of diagram source code for use in generating a sequence diagram that represents the given BDD test script, wherein the corresponding set of diagram source code represents interactions between entities involved in the at least one behavioral scenario; and
based on the set of diagram source code, cause the sequence diagram that represents the given BDD test script to be generated and displayed to a user.
